(19) United States
(12) Patent Application Publication
(10) Pub. No.: US 2024/0396357 A1
(43) Pub. Date: Nov. 28, 2024

(54) SECONDARY BATTERY MANAGEMENT SYSTEM

(71) Applicant: SEMICONDUCTOR ENERGY LABORATORY CO., LTD., Atsugi-shi, Kanagawa-ken (JP)

(72) Inventors: Takeshi OSADA, Isehara, Kanagawa, (JP); Haruki KATAGIRI, Atsugi, Kanagawa (JP); Kyoichi MUKAO, Odawara, Kanagawa (JP); Mayumi MIKAMI, Atsugi, Kanagawa (JP); Kazutaka KURIKI, Ebina, Kanagawa (JP); Kazuki TANEMURA, Isehara, Kanagawa (JP)

(21) Appl. No.: 18/687,412

(22) PCT Filed: Aug. 22, 2022
(86) PCT No.: PCT/IB2022/057828

§ 371 Date: Feb. 28, 2024

(30) Foreign Application Priority Data
Aug. 31, 2021 (JP) 2021-141791

(51) Int. Cl. H02J 7/00; H01M 10/42

(52) U.S. Cl. CPC H02J 7/007182; H01M 10/425; H01M 2010/4271

(57) ABSTRACT

A secondary battery management system for achieving a secondary battery capable of being used even at low temperatures. The secondary battery management system includes a secondary battery that is charged and discharged at higher than or equal to −50° C. and lower than or equal to 0° C., a first circuit having a function of measuring a voltage of the secondary battery, a second circuit having a function of measuring a current of the secondary battery, and a control circuit to which information on voltage from the first circuit or information on current from the second circuit is input. The control circuit starts charging to the secondary battery. The control circuit performs arithmetic operation of data showing battery characteristics on the basis of a value input from the first circuit or the second circuit. The control circuit detects a local maximum value of the data. The control circuit stops the charging when detecting the local maximum value.

### TECHNICAL FIELD

One embodiment of the present invention relates to a secondary battery management system.

Note that one embodiment of the present invention is not limited to the above technical field. Examples of the technical field of one embodiment of the present invention disclosed in this specification and the like include a semiconductor device, a light-emitting device, a power storage device, a memory device, an electronic device, a lighting device, an input device, an input/output device, and manufacturing methods thereof.

### BACKGROUND ART

Unlike a primary battery, a secondary battery can be used repeatedly by charging, and is also referred to as a storage battery or a battery. Charging means the process of sending electricity to a secondary battery, while discharging means the process of taking electricity out of the secondary battery. A secondary battery using lithium ions as carrier ions is referred to as a lithium-ion secondary battery or a lithium-ion battery. A lithium-ion secondary battery can have high capacity and be compact, and is mounted on an electronic device or the like.

The upper limit of voltage for charging the secondary battery is determined in consideration of safety, and is referred to as an upper limit voltage in this specification and the like. The upper limit voltage is also referred to as a maximum charging voltage, a termination voltage, a specified voltage, or a full charge voltage. The upper limit voltage of a secondary battery using lithium cobalt oxide for a positive electrode and graphite for a negative electrode is approximately 4.2 V. When the upper limit voltage is increased, the capacity of the secondary battery is increased; thus, research and development on a method of increasing the upper limit voltage have been conducted.

As for the method of increasing the upper limit voltage, the charging power limit is described in Patent Document 1. The charging power limit in Patent Document 1 is determined by predicting the terminal voltage and the entire resistance of a secondary battery using an equivalent circuit model of the secondary battery and using the predicted terminal voltage and entire resistance. Patent Document 1 also describes that the temperature measured in the temperature measurement unit is transmitted to the control unit, and the voltage source determines the open circuit voltage (V_{OCV}) from the state of charge (SOC) and the temperature of the secondary battery.

### REFERENCE

### Patent Document

[Patent Document 1] Japanese Translation of PCT International Application No. 2020-524875

### SUMMARY OF THE INVENTION

### Problems to be Solved by the Invention

In Patent Document 1, a crystal structure of an active material, for example, a positive electrode active material, is not taken account for determining the charging power limit. Accordingly, in the prediction using merely an equivalent circuit model in Patent Document 1, the charging power limit cannot be sufficiently increased in some cases.

Furthermore, Patent Document 1 is not aware of low temperatures such as −40° C. The battery characteristics at the low temperature are significantly different from the battery characteristics at around 25° C., what is called room temperature, and the discharge capacity at low temperatures is lower than that at room temperature. Therefore, an increase in the upper limit voltage is particularly desired at low temperatures.

In view of the above, an object of one embodiment of the present invention is to increase the upper limit voltage to the maximum and to provide a secondary battery management system that enables charging and discharging even at low temperatures.

Note that the description of these objects does not preclude the existence of other objects. These objects should be construed as being independent of one another, and one embodiment of the present invention only needs to achieve at least one of these objects and does not need to achieve all the objects. Furthermore, other objects can be derived from the description of the specification, the drawings, and the claims, which are the present specification and the like.

### Means for Solving the Problems

In view of the above objects, by taking the crystal structure of a positive electrode active material into consideration and finding an optimal voltage, one embodiment of the present invention can increase the upper limit voltage to the limit and provide a secondary battery management system that enables charging and discharging even at low temperatures. Note that in this specification and the like, a low temperature refers to a temperature higher than or equal to −50° C. and lower than or equal to 0° C., room temperature refers to a temperature higher than 0° C. and lower than or equal to 35° C., and a high temperature refers to a temperature higher than 35° C. and lower than or equal to 65° C. The temperature lower than 0° C. is referred to as a temperature below freezing in some cases.

One embodiment of the present invention is a secondary battery management system including a secondary battery that is charged and discharged at higher than or equal to −50° C. and lower than or equal to 0° C., a first circuit having a function of measuring a voltage of the secondary battery, a second circuit having a function of measuring a current of the secondary battery, and a control circuit to which information on voltage from the first circuit or information on current from the second circuit is input. The control circuit starts charging to the secondary battery. The control circuit performs arithmetic operation of data showing battery characteristics on the basis of a value input from the first circuit or the second circuit. The control circuit detects a local maximum value of the data. The control circuit stops the charging when detecting the local maximum value.

One embodiment of the present invention is a secondary battery management system including a secondary battery that is charged and discharged at higher than or equal to −50° C. and lower than or equal to (° C.), a first circuit having a function of measuring a voltage of the secondary battery, a second circuit having a function of measuring a current of the secondary battery, a control circuit to which information on voltage from the first circuit or information on current from the second circuit is input, and a temperature sensor electrically connected to the control circuit. The control circuit measures a temperature of the secondary battery using the temperature sensor. The control circuit starts charging to the secondary battery. The control circuit performs arithmetic operation of data showing battery characteristics on the basis of a value input from the first circuit or the second circuit. The control circuit detects a local maximum value of the data. The control circuit stops the charging when detecting the local maximum value.

One embodiment of the present invention is a secondary battery management system including a secondary battery that is charged and discharged at higher than or equal to −50° C. and lower than or equal to 0° C., a first circuit having a function of measuring a voltage of the secondary battery, a second circuit having a function of measuring a current of the secondary battery, and a control circuit to which information on voltage from the first circuit or information on current from the second circuit is input. The control circuit stores a temperature of the secondary battery in a memory circuit. The control circuit starts charging to the secondary battery. The control circuit performs arithmetic operation of a dt/dV value showing the battery characteristics on the basis of the temperature on the basis of a value input from the first circuit or the second circuit. The control circuit detects a local maximum value of the dt/dV. The control circuit stops the charging when detecting the local maximum value.

In one embodiment of the present invention, it is preferable that the control circuit perform averaging processing on the dt/dV, and a difference value between a second value and a first value of the dt/dV in a comparison range can be divided by the first value.

In one embodiment of the present invention, charging is preferably performed with a constant current.

In one embodiment of the present invention, it is preferable that the secondary battery include a positive electrode, the positive electrode include lithium cobalt oxide, and a crystal structure identified by X-ray diffraction be a crystal structure represented by a space group R-3m.

In one embodiment of the present invention, lithium cobalt oxide preferably includes magnesium in a surface portion.

In one embodiment of the present invention, it is preferable that the secondary battery include a negative electrode and the negative electrode include lithium metal or graphite.

### Effect of the Invention

One embodiment of the present invention can provide a secondary battery management system capable of increasing the upper limit voltage to the maximum. One embodiment of the present invention can provide a secondary battery management system capable of charging and discharging even at low temperatures.

Note that the description of these effects does not preclude the existence of other effects. These effects should be construed as being independent of one another, and one embodiment of the present invention only needs to have at least one of these effects and does not need to achieve all the effects. Furthermore, other effects can be derived from the description of the specification, the drawings, and the claims, which are the present specification and the like.

### BRIEF DESCRIPTION OF THE DRAWINGS

FIG. 1A to FIG. 1C are block diagrams illustrating examples of a secondary battery management system.

FIG. 2A and FIG. 2B are block diagrams illustrating examples of a secondary battery management system.

FIG. 3 is a flowchart showing a method of charging a secondary battery management system.

FIG. 4 is a flowchart showing a method of charging a secondary battery management system.

FIG. 5 is a block diagram illustrating an example of a secondary battery management system.

FIG. 6 is a block diagram illustrating an example of a secondary battery management system.

FIG. 7A and FIG. 7B are block diagrams illustrating an example of a secondary battery management system.

FIG. 8 is a flowchart showing differential processing.

FIG. 9 is a diagram showing crystal structures of a positive electrode active material.

FIG. 10A to FIG. 10C are diagrams illustrating an example of a method of forming a positive electrode active material.

FIG. 11 is a diagram illustrating an example of a method of forming a positive electrode active material.

FIG. 12 is a diagram illustrating an example of a method of forming a positive electrode active material.

FIG. 13A to FIG. 13C are diagrams illustrating an example of a method of forming a positive electrode active material.

FIG. 14 is a diagram illustrating an example of a laminated secondary battery.

FIG. 15A to FIG. 15C are diagrams illustrating an example of a method of manufacturing a laminated secondary battery.

FIG. 16A and FIG. 16B are diagrams illustrating an example of a bendable secondary battery.

FIG. 17A and FIG. 17B are diagrams illustrating part of a bendable secondary battery.

FIG. 18 is a block diagram illustrating an example of a vehicle including a motor.

FIG. 19A to FIG. 19E are diagrams illustrating examples of transport vehicles.

FIG. 20A and FIG. 20B are diagrams illustrating a house that utilizes a secondary battery.

FIG. 21A to FIG. 21E are diagrams illustrating examples of electronic devices.

FIG. 22A to FIG. 22C are diagrams illustrating examples of electronic devices.

FIG. 23A to FIG. 23D are diagrams illustrating examples of electronic devices and the like.

FIG. 24 is a graph showing the results of Example.

FIG. 25 is a graph showing the results of Example.

### MODE FOR CARRYING OUT THE INVENTION

Embodiments will be described below with reference to the drawings. Note that the embodiments can be implemented with many different modes, and it is readily understood by those skilled in the art that modes and details can be changed in various ways without departing from the spirit and scope. Thus, the present invention should not be construed as being limited to the description of embodiments below.

Ordinal numbers such as “first”, “second”, and “third” in this specification and the like are used in order to avoid confusion among components. Thus, the terms do not limit the number or order of components.

In some cases, the same components, components having similar functions, components made of the same material, components formed at the same time, and the like are denoted by the same reference numerals in the drawings and repeated description of the components having the same reference numerals is omitted in this specification and the like.

In a top view (also referred to as a plan view), a perspective view, and the like, some components might not be illustrated for easy understanding of the drawings.

In this specification and the like, “electrically connected” includes the case where components are directly connected to each other and the case where components are connected through an “object having any electric function”. Here, there is no particular limitation on the “object having any electric function” as long as electric signals can be transmitted and received between components that are connected through the object. Thus, even when the expression “electrically connected” is used, there is a case where no physical connection is made in an actual circuit.

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing-(a minus sign) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region ranging from the surface to a depth of 10 nm, a depth of 50 nm, or a depth of 5 nm, in a perpendicular direction or a substantially perpendicular direction from the surface toward the inner portion. The surface portion can be rephrased as the vicinity of the surface, a region in the vicinity of the surface, or a shell. Note that “perpendicular” or “substantially perpendicular” specifically means that an angle between a direction and a surface is greater than or equal to 80° and less than or equal to 100°. A plane generated by a fissure or a crack can be considered as a surface. A region in a position deeper than the surface portion of a positive electrode active material is referred to as a bulk. The bulk is rephrased as an inner portion or the core.

In this specification and the like, in the case where lithium is used as a carrier ion, in a layered rock-salt crystal structure of a composite oxide containing lithium and a transition metal, a rock-salt ion arrangement where cations and anions are alternately arranged is included and the transition metal and lithium are regularly arranged to form a plane, so that lithium can be two-dimensionally diffused. Note that the composite oxide may have a defect such as a cation or anion vacancy. Moreover, in the layered rock-salt crystal structure, a lattice of a rock-salt crystal structure is distorted in some cases. In this specification and the like, a rock-salt crystal structure refers to a structure in which cations and anions are alternately arranged. Note that the rock-salt crystal structure may have a cation or anion vacancy.

In this specification and the like, an O3′ type crystal structure of a composite oxide containing lithium and a transition metal belongs to a space group R-3m, and is not a spinel crystal structure but a crystal structure in which an ion of cobalt, magnesium, or the like occupies a site coordinated to six oxygen atoms and the cation arrangement has symmetry similar to that of the spinel crystal structure. Note that in the O3′ type crystal structure, a light element such as lithium sometimes occupies a site coordinated to four oxygen atoms.

The O3′ type crystal structure can be regarded as a crystal structure that contains Li between layers randomly but is similar to a CdCl₂ crystal structure. A layered rock-salt type positive electrode active material that contains a large amount of a known lithium cobalt oxide or cobalt is known not to have a crystal structure similar to the CdCl₂ crystal structure under normal circumstances.

Anions of a layered rock-salt crystal structure and anions of a rock-salt crystal structure each form a cubic close-packed structure (face-centered cubic lattice structure). When a layered rock-salt crystal structure and a rock-salt crystal structure are in contact with each other, there is a crystal plane at which orientations of cubic close-packed structures formed of anions are aligned with each other. Note that a space group of the layered rock-salt crystal structure is R-3m, which is different from space groups of the rock-salt crystal structure, Fm-3m (a space group of a general rock-salt crystal) and Fd-3m (a space group of a rock-salt crystal having the simplest symmetry); thus, the Miller indexes of the crystal planes when the orientations are aligned are different from each other. In this specification and the like, a state where the orientations of the cubic close-packed structures formed of anions in the layered rock-salt crystal structure and the rock-salt crystal structure are aligned with each other is referred to as a state where crystal orientations are aligned or substantially aligned with each other in some cases. Since anions of an O3′ type crystal structure are presumed to form a cubic close-packed structure, the crystal plane at which the orientations of the rock-salt crystal structure are aligned with each other can be understood by replacing the layered rock-salt crystal structure with the O3′ type crystal structure.

The space group of a crystal structure is identified by X-ray diffraction (XRD), electron diffraction, neutron diffraction, or the like. Measurement by XRD or the like is performed at room temperature or higher. Thus, in this specification and the like, being attributed to a space group, belonging to a space group, or being a space group can be rephrased as being identified as the space group.

In this specification and the like, a structure is referred to as a cubic close-packed structure when three layers of anions are shifted and stacked like “ABCABC” in the structure. Accordingly, anions do not necessarily form a precise cubic lattice structure. At the same time, actual crystals have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

A secondary battery includes a positive electrode and a negative electrode, for example. A positive electrode active material is a material included in the positive electrode. The positive electrode active material is a substance that performs a reaction contributing to the charge and discharge capacity; specifically, the positive electrode active material lithium is a compound containing oxygen and a transition metal into and from which lithium can be inserted and extracted, or a composite oxide containing a transition metal. The positive electrode active material is sometimes referred to as a composite oxide, a positive electrode member, a positive electrode material, a lithium-ion battery positive electrode member, or the like.

When a secondary battery is used at low temperatures, battery characteristics, such as a discharge curve, are different from those at room temperature. For example, when the secondary battery is used at low temperatures, the discharge capacity tends to be lower than that at room temperature. That is, in order to obtain the same value of discharge capacity, a voltage used at low temperatures is sometimes higher than that at room temperature. Thus, the secondary battery management system of one embodiment of the present invention can change optimal charging and discharging conditions depending on the operating temperature of the secondary battery.

As for the secondary battery management system of one embodiment of the present invention, the temperature of the secondary battery includes a temperature inside the secondary battery and a temperature outside the secondary battery. Furthermore, the temperature outside the secondary battery includes a temperature of an exterior body of the secondary battery, a temperature of a housing in which the exterior body is provided, a temperature of an environment in which the secondary battery is placed. In this specification and the like, the environmental temperature is sometimes referred to as an operating temperature of the secondary battery. Although the temperatures can be distinguished from each other as described above depending on the position of a temperature sensor in the secondary battery management system, the secondary battery management system can be provided at any temperature.

A temperature of a charge and discharge cycle test in this specification and the like refers to a temperature of a thermostatic bath where a lithium-ion secondary battery is placed. Measurement is preferably started after adequate time (e.g., an hour or longer) elapses so that a temperature of a lithium-ion secondary battery to be measured (e.g., a test battery) which is placed in the thermostatic bath becomes approximately equal to the temperature of the thermostatic bath. The temperature of the thermostatic bath corresponds to the temperature of the secondary battery management system.

In charging a secondary battery at a low temperature, an energy barrier at the time of extracting lithium ions from a positive electrode active material tends to become high. That is, as the temperature at the time of charging becomes lower, the amount of overvoltage needed for extraction of lithium ions from the positive electrode active material becomes larger; thus, the positive electrode active material might be exposed to high voltage (a high potential with respect to a lithium potential). In other words, in charging at a low temperature, charge capacity might be decreased when the positive electrode active material is not exposed to high voltage. Thus, the present inventors thought that as a positive electrode active material included in a lithium-ion battery having excellent charge characteristics and discharge characteristics even at low temperatures, a positive electrode active material that can withstand high voltage is preferably used.

When the positive electrode active material is exposed to high voltage, the crystal structure might start to be broken, which might inhibit carrier ions from coming in and out of the positive electrode active material. Thus, the present inventors thought that it is important to maximize the upper limit voltage in a range where the crystal structure is not broken, and found out the secondary battery management system.

A theoretical capacity of a positive electrode active material refers to the quantity of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium in a positive electrode active material, which is compared to the theoretical capacity, is represented by x in a compositional formula, e.g., LiₓCoO₂ or LiₓMO₂. Here, M means a transition metal that is oxidized or reduced due to insertion and extraction of lithium. In this specification, LiₓCoO₂ can be replaced with LiₓMO₂ as appropriate. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24.

In the case where lithium cobalt oxide substantially satisfies the stoichiometric composition, the lithium cobalt oxide is LiCoO₂ and the occupancy rate x of Li in lithium sites is 1. For a secondary battery after its discharging ends, it can be said that lithium cobalt oxide is LiCoO₂ and x=1. Here, “discharging ends” means that a voltage becomes lower than or equal to 2.5 V (lithium counter electrode) at a current of 100 mA/g, for example. In a lithium-ion secondary battery, the voltage rapidly decreases when the occupancy rate of lithium in the lithium sites becomes x=1 and no more lithium can enter the lithium-ion secondary battery. At this time, it can be said that discharging ends. In general, in a lithium-ion secondary battery using LiCoO₂, the discharging voltage rapidly decreases before discharging voltage reaches 2.5 V; thus, discharging ends under the above-described conditions.

When general LiCoO₂ is used as the positive electrode active material and charging is performed with a voltage at which x in LiₓCoO₂ becomes larger than or equal to 0.2, the crystal structure changes from the O3 structure to the H1-3 structure. When discharging after the charging by which the crystal structure changes to the H1-3 structure is performed, the crystal structure sometimes does not return to the O3 structure, which is the original crystal structure. In this specification and the like, a crystal structure which has the H1-3 structure and does not return to the O3 structure is referred to as an irreversible crystal structure. The area where the crystal structure is not broken can be regarded as a range where LiCoO₂ does not have an irreversible crystal structure.

To grasp the crystal structure of a positive electrode active material or the like in the secondary battery management system, information on the secondary battery is desired to be obtained non-destructively, and data showing the battery characteristics is employed. An example of the data is a value indicating a change in voltage (sometimes referred to as a terminal voltage) with respect to time. Since the change in voltage with respect to time is a curve with an observable peak when shown in a graph, information on the secondary battery can be obtained non-destructively by the peak position or the peak intensity. The peak is a local maximum value and two or more peaks may exist.

Another example of the data is a value of dQ/dV (denoted as dQ/dV) which is the ratio of the change amount dQ of the electric quantity (referred to as the amount of electric charge) Q of the secondary battery with respect to the change amount dV of the voltage V of the secondary battery. Since dQ/dV is a curve when shown in a graph, the curve is sometimes referred to as a dQ/dV curve. A peak is observed in the dQ/dV curve, and information on the secondary battery can be obtained non-destructively by the peak position or the peak intensity. The peak is a local maximum value and two or more peaks may exist.

Since the above-described change amount can be represented by a function of time, the change amount dV of the voltage V is represented by dV (t) and the change amount dQ of the electric quantity Q is represented by dQ (t) in some cases.

These data showing the battery characteristics can be obtained at regular time intervals with the secondary battery management system. That is, with use of data showing the battery characteristics, the latest information on the secondary battery reflecting the operating temperature can be obtained.

As described above, the data showing the battery characteristics varies depending on the temperature of the secondary battery. Thus, the secondary battery management system of one embodiment of the present invention can select, from the above data, the optimal data used for determining the upper limit voltage. For example, the secondary battery management system can grasp the temperature of the secondary battery and select data showing the battery characteristics in accordance with the temperature.

Then, the secondary battery management system of one embodiment of the present invention detects a local maximum value of the data showing the battery characteristics.

In order to detect a local maximum value, smoothing processing for removing a noise or processing for emphasizing a local maximum value may be performed on the secondary battery management system of one embodiment of the present invention.

In order to detect a local maximum value, the secondary battery management system of one embodiment of the present invention can grasp in advance a voltage of the secondary battery at which the crystal structure becomes an irreversible crystal structure and set a predetermined voltage range for detection.

In order to detect a local maximum value, the secondary battery management system of one embodiment of the present invention can grasp in advance the electric quantity of the secondary battery at which the crystal structure becomes an irreversible crystal structure and set a predetermined electric quantity range for detection.

In order to detect a local maximum value, the secondary battery management system of one embodiment of the present invention can grasp in advance a charging time in which the crystal structure becomes the above-described irreversible crystal structure and set a predetermined charging time range for detection.

The secondary battery management system of one embodiment of the present invention can stop charging after the local maximum value is detected. The local maximum value is a value within a range where the crystal structure is not broken, and charging is preferably stopped on the basis of the local maximum value because the upper limit voltage can be maximum in the range where the crystal structure is not broken.

The above-described data showing the battery characteristics reflects the temperature of the secondary battery. Thus, with use of the secondary battery management system of one embodiment of the present invention, the optimal upper limit voltage can be determined in accordance with the temperature, and the secondary battery management system is particularly suitable for obtaining the upper limit voltage of the secondary battery used at low temperatures.

Although the secondary battery used at low temperatures is described, the secondary battery management system of one embodiment of the present invention can also be used at high temperatures. Needless to say, the secondary battery management system of one embodiment of the present invention can also be used at room temperature.

Furthermore, in the secondary battery management system of one embodiment of the present invention, constant current charging is preferably performed from the start of charging to the stop of charging. This is because even when time is required to stop the charging in the secondary battery management system, the upper limit voltage is not rapidly changed in the constant current charging period.

### Embodiment 1

In view of the above, in this embodiment, a secondary battery management system of one embodiment of the present invention will be described.

### Example 1 of Secondary Battery Management System

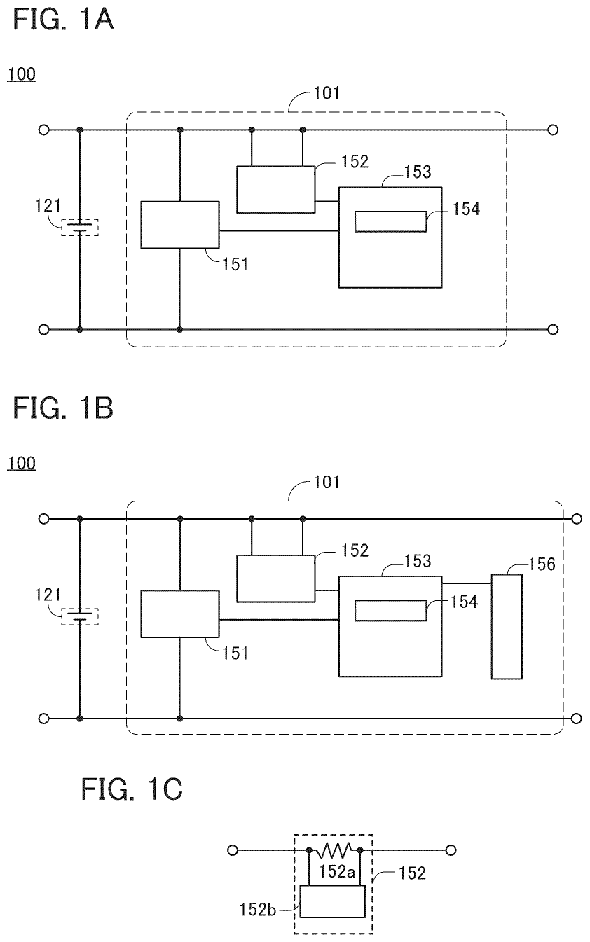

FIG. 1A illustrates an example of a secondary battery management system 100 of one embodiment of the present invention. The secondary battery management system 100 can operate at low temperatures, room temperature, and high temperatures. Specifically, the secondary battery management system 100 includes a secondary battery 121 that performs charging and discharging at a temperature higher than or equal to −50° C. and lower than or equal to 0° C.

Furthermore, the secondary battery management system 100 includes a charging circuit 101. The charging circuit 101 is electrically connected to the secondary battery 121. Specifically, the charging circuit 101 is electrically connected to a positive electrode and a negative electrode of the secondary battery 121. A positive electrode terminal such as a positive electrode lead or a positive electrode tab is provided in the secondary battery 121 as the positive electrode in some cases. A negative electrode terminal such as a negative electrode lead or a negative electrode tab is provided in the secondary battery 121 as a negative electrode in some cases. In this case, the charging circuit 101 is electrically connected to the positive electrode terminal and the negative electrode terminal.

The charging circuit 101 illustrated in FIG. 1A includes at least a voltage measuring circuit 151, a current measuring circuit 152, and a control circuit 153. The charging circuit 101 illustrated in FIG. 1B is different from that in FIG. 1A and further includes a temperature sensor 156.

### <Voltage Measuring Circuit>

The voltage measuring circuit 151 is electrically connected to the positive electrode and the negative electrode of the secondary battery 121 as illustrated in FIG. 1A and FIG. 1B. The voltage measuring circuit 151 may be electrically connected to the positive electrode terminal and the negative electrode terminal.

The voltage measuring circuit 151 has a function of measuring voltage of the secondary battery 121 (referred to as a terminal voltage), and for example, has a function of measuring a terminal voltage (referred to as a charging voltage) when the secondary battery 121 is being charged. The voltage measuring circuit 151 may have a function of measuring a terminal voltage (referred to as a discharging voltage) when the secondary battery 121 is being discharged besides the charging voltage. To distinguish the charging voltage and the discharging voltage, for example, the charging voltage may be denoted by a plus sign, and the discharging voltage may be denoted by a minus sign. Needless to say, the charging voltage may be denoted by a minus sign and the discharging voltage may be denoted by a plus sign.

The timing at which the voltage measuring circuit 151 measures each voltage can be set at fixed time intervals, and the fixed time interval can be greater than or equal to 80 msec and less than or equal to 10 sec, preferably greater than or equal to 90 msec and less than or equal to 1 sec. When the period is shortened, the state of the secondary battery can be grasped with high accuracy. For example, the period can be shortened only when the change in the voltage of the secondary battery is large.

The voltage measuring circuit 151 can measure the charging voltage and the discharging voltage of the secondary battery 121. For example, in the case where the secondary battery is placed at a low temperature, the voltage measuring circuit 151 can measure the charging voltage and the discharging voltage at the low temperature. The voltage measuring circuit 151 can supply a measured voltage value to the control circuit 153. In the case where the measured voltage value is an analog value, the analog value may be converted to a digital value and supplied to the control circuit 153. That is, the voltage measuring circuit 151 may include a circuit that converts an analog value to a digital value, and an analog-digital converter circuit (ADC) can be used as the circuit. The ADC has a configuration of a ΔΣ modulation type, a parallel comparison type (also referred to as a flash type), a pipeline type, or the like. The 42 modulation type ADC has high resolution and is suitable for the voltage measuring circuit.

### Example 1 of Measuring Voltage Vb1

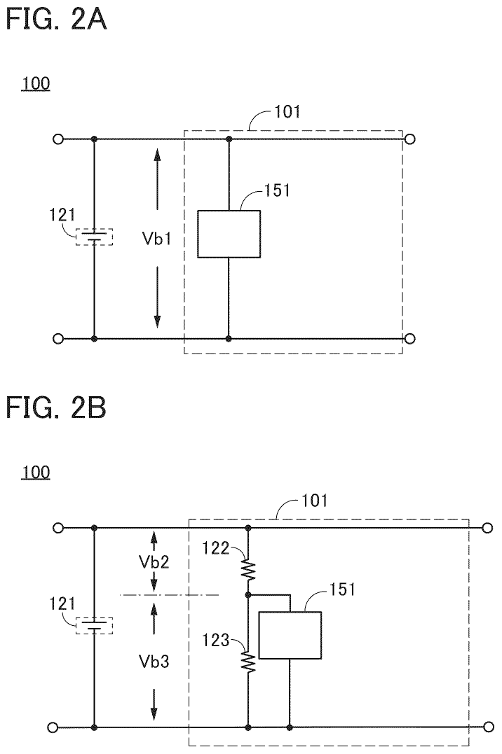

Measurement example 1 of a voltage Vb1 between the positive electrode and the negative electrode of the secondary battery is described with reference to FIG. 2A. Only the voltage measuring circuit 151 is illustrated in the charging circuit 101 in FIG. 2A, and other components are omitted. As illustrated in FIG. 2A, the voltage measuring circuit 151 can directly measure the voltage Vb1 between the positive electrode and the negative electrode of the secondary battery.

### Example 2 of Measuring Voltage Vb1

As illustrated in FIG. 2B, the voltage measuring circuit 151 can measure the voltage Vb1 divided by resistors. Only the voltage measuring circuit 151 is illustrated in the charging circuit 101 in FIG. 2B, and other components are omitted. In FIG. 2B, the voltage Vb1 is divided into a voltage Vb2 and a voltage Vb3 by a resistor 122 and a resistor 123, and the voltage measuring circuit 151 can measure the voltage Vb3, for example. In order to measure the voltage Vb3, the voltage measuring circuit 151 is electrically connected to the negative electrode of the secondary battery 121 and a node between the resistor 122 and the resistor 123.

In the case where the voltage measuring circuit 151 measures voltages obtained by resistor division of the voltage between the positive electrode and the negative electrode of the secondary battery 121, the voltage measuring circuit 151 or the control circuit 153 may estimate the voltage Vb1 between the positive electrode and the negative electrode of the secondary battery 121 from the voltages obtained divided by resistors.

### <Current Measuring Circuit>

The current measuring circuit 152 is electrically connected to the positive electrode of the secondary battery 121 as illustrated in FIG. 1A and FIG. 1B. The current measuring circuit 152 may be electrically connected to the positive electrode terminal.

The current measuring circuit 152 has a function of measuring a current flowing between the positive electrode and the negative electrode of the secondary battery 121, for example, preferably has a function of measuring a current (referred to as a charging current) when the secondary battery 121 is being charged. The current measuring circuit 152 may have a function of measuring a current (referred to as a discharging current) when the secondary battery 121 is being discharged besides the charging voltage.

FIG. 1C illustrates a specific example of the current measuring circuit 152. The current measuring circuit 152 preferably includes a resistor 152a and a circuit 152b, and the circuit 152b is preferably electrically connected to the control circuit 153. A shunt resistor is preferably used as the resistor 152a. The resistivity of the shunt resistor is greater than or equal to 10 mΩ and less than or equal to 300 mΩ preferably greater than or equal to 50 mΩ and less than or equal to 120 mΩ. The circuit 152b preferably includes an operational amplifier. An operational amplifier is preferable because it can amplify a voltage drop due to the shunt resistor.

The current measuring circuit 152 can measure the charging current and the discharging current in accordance with the temperature of the secondary battery 121. For example, in the case where the secondary battery 121 is placed at a low temperature, the current measuring circuit 152 can measure the charging current and the discharging current at the low temperature. The current measuring circuit 152 can supply a measured current value to the control circuit 153. Although the measured current value is an analog value, the analog value may be converted to a digital value and then supplied to the control circuit 153, and as an analog-digital converter circuit (ADC), the above-described one can be used.

### <Control Circuit>

The control circuit 153 has a function of starting the charging of the secondary battery and a function of stopping the charging on the basis of information on the above-described voltage and current. In addition, the control circuit 153 has an arithmetic function, a detection function, a determination function, or the like.

As the control circuit 153 having the above-described functions, a central processing unit (CPU), a microcontroller unit (MCU), or the like can be used.

In the case where the secondary battery 121 is placed at a low temperature, the control circuit 153 can operate even at the low temperature.

In the secondary battery management system 100, a heater may be provided in contact with the control circuit 153 or in the vicinity of the control circuit 153. With the heater, operation of the control circuit 153 placed at a low temperature can be surely performed.

### <Memory Circuit>

The control circuit 153 preferably includes a memory circuit 154 illustrated in FIG. 1A and FIG. 1B, in addition to a CPU or an MCU. The control circuit 153 can store a value input from the voltage measuring circuit 151, the current measuring circuit 152, or the like in the memory circuit 154.

### <Temperature Sensor>

The secondary battery management system 100 may include the temperature sensor 156 illustrated in FIG. 1B. The temperature of the secondary battery can be measured by the temperature sensor 156. The temperature sensor 156 measures temperatures in a range from a low temperature to a high temperature. Temperatures that can be measured by the temperature sensor 156 are determined by the position where the temperature sensor 156 is placed. When the temperature sensor is placed inside the secondary battery, the temperature inside the secondary battery can be measured. When the temperature sensor is placed in contact with the exterior body of the secondary battery, the temperature of the exterior body of the secondary battery can be measured. When the temperature sensor is placed between the exterior body and the housing of the secondary battery and in contact with the housing, the temperature of the housing can be measured. When the temperature sensor is placed near the secondary battery, the environmental temperature of the secondary battery can be measured.

As the temperature sensor in contact with the exterior body or the temperature sensor in contact with the housing, a temperature sensor having a T thermocouple function can be used, for example. The control circuit 153 can store a value input from the temperature sensor 156 in the memory circuit 154.

The information on temperature obtained from the temperature sensor 156 is used for determining the upper limit voltage in the secondary battery management system 100. In particular, in the case where the secondary battery is used continuously at different temperatures, for example, from a low temperature to a high temperature or from a low temperature to room temperature, the information on temperature is useful for determining the upper limit voltage in the secondary battery management system 100.

Note that the upper limit voltage can be determined even in a secondary battery management system not provided with a temperature sensor as long as data showing the battery characteristics can be obtained.

### <External Power Source>

The electric power of each circuit included in the charging circuit may be shared by the secondary battery 121, or may be supplied from a secondary battery different from the secondary battery 121 or a power supply device. For example, the secondary battery management system 100 can be electrically connected to an external power source, and electric power from the external power source may be used as electric power of each circuit included in the charging circuit.

### <Arithmetic Function and Detection Function>

With the arithmetic function of the control circuit 153, the data showing the battery characteristics can be calculated from the measurement values of voltage, current, the time, and the like. Furthermore, with the detection function of the control circuit 153, the local maximum value can be detected from the data. Note that with the detection function, the local maximum value can be determined when a decrease from the local maximum value is observed.

### Example 1 of Detecting Local Maximum Value

A time-dependent change in voltage of the secondary battery 121 can be calculated with use of the arithmetic function of the control circuit 153, for example. With this function, the secondary battery management system 100 can obtain a numeral value or a graph relating to a change in voltage with time (ΔV). In the graph, one or more local maximum values are observed in some cases. The local maximum value is derived from a change in the crystal structure, and shows that the crystal structure of an active material starts to change with the local maximum value as a boundary.

<dt/dV>

The control circuit 153 can differentiate the obtained time with respect to voltage by using the arithmetic function, for example. With this function, the secondary battery management system 100 can obtain a numerical value or a graph relating to dt/dV. In the graph, one or more local maximum values are observed. The local maximum value is derived from a change in the crystal structure, and shows that the crystal structure of an active material starts to change with the local maximum value as a boundary. The change is sometimes referred to as a phase change.

The secondary battery management system 100 can grasp a change in the crystal structure of the positive electrode active material or the like from dt/dV. Note that there are a reversible change and an irreversible change as changes in the crystal structure; however, when an irreversible change occurs, an active material or the like deteriorates. Thus, the control circuit 153 has a function of detecting one of local maximum values corresponding to the start of the irreversible change and determining a voltage of the secondary battery in a state of reaching the local maximum value as the upper limit voltage.

In the data showing the battery characteristics, a plurality of local maximum values are observed when reversible changes in the crystal structure are included. In the secondary battery management system 100, one of local maximum values corresponding to the start of an irreversible change in the crystal structure is desired to be detected. For this reason, a local maximum value relating to a reversible crystal structure is preferably ignored in the secondary battery management system 100. As an ignoring method, a range corresponding to an irreversible change in the crystal structure is preferably determined in advance. In the case where an irreversible change in the crystal structure occurs in the vicinity of the upper limit voltage, the lower limit of the range is set −10%, preferably −8% of the upper limit voltage. Note that the upper limit of the range is the upper limit voltage.

Although the range is determined on the basis of the charging voltage in the above description, the lower limit of the range can be determined on the basis of the time corresponding to the charging voltage. The lower limit of the range can be determined on the basis of the quantity of electricity corresponding to the charging voltage.

A charging voltage at which an irreversible change in the crystal structure occurs may be grasped in advance by performing one or more cycles of charging and discharging on the secondary battery. The lower limit of the range can be −8%, preferably −5% of the charging voltage at which an irreversible change in the crystal structure occurs.

In the above range, the local maximum value is detected.

### <Averaging Processing>

In the case where a clear local maximum value cannot be observed, the control circuit 153 can perform averaging processing of the dt/dV value, with use of the arithmetic function, for example. The average value of ten points can be obtained by the averaging processing, and is referred to as a moving average in some cases. The number of points for obtaining the average value is not limited to ten. Such averaging processing facilitates detection of a local maximum value. In some cases, the averaging processing is referred to as smoothing processing.

### <Change Rate>

In the case where a clear local maximum value cannot be observed, the control circuit 153 can obtain a change rate, with use of the arithmetic function, for example. The change rate can be calculated from a value after the averaging processing. With respect to the average value of the ten points, a comparison range including 100 points is set, for example, and the change rates at the 100 points can be calculated. The change rate can be obtained by executing processing to subtract a value at the first point (a first value) from a value at the 100th point (a second value), and then dividing an obtained difference value by the value at the first point. Note that the comparison range for obtaining the change rate is not limited to 100 points. When the change rate is obtained, the local maximum value is easily detected.

### <Arithmetic Function and Detection Function>

The control circuit 153 can calculate the quantity of electricity of the secondary battery by using the arithmetic function, for example, with the use of a voltage of the secondary battery 121 supplied by the voltage measuring circuit 151 or a current of the secondary battery 121 supplied by the current measuring circuit 152. With this function, the secondary battery management system 100 can obtain a numeral value or a graph relating to a voltage (V) with respect to a capacitance (C).

<dQ/dV>

The control circuit 153 can differentiate the obtained electric quantity with respect to voltage by using the arithmetic function, for example. With this function, the secondary battery management system 100 can obtain a numerical value or a graph relating to dQ/dV. Note that in the graph showing dQ/dV, the horizontal axis represents voltage V(t) and the vertical axis represents dQ(t)/dV(t).

### Example 2 of Detecting Local Maximum Value

In the graph showing dQ/dV, one or more local maximum values are detected. The local maximum value is derived from a change in the crystal structure, and shows that the crystal structure of an active material starts to change with the local maximum value as a boundary. The change is sometimes referred to as a phase change.

The secondary battery management system 100 can grasp a change in the crystal structure of the positive electrode active material or the like from dQ/dV. Note that there are a reversible change and an irreversible change as changes in the crystal structure; however, when an irreversible change occurs, an active material or the like deteriorates. Thus, the control circuit 153 has a function of detecting one of local maximum values corresponding to the start of the irreversible change and determining a voltage of the secondary battery in a state of reaching the local maximum value as the upper limit voltage.

In the data showing the battery characteristics, a plurality of local maximum values are observed when reversible changes in the crystal structure are included. In the secondary battery management system 100, one of local maximum values corresponding to the start of an irreversible change in the crystal structure is desired to be detected. For this reason, a local maximum value relating to a reversible crystal structure is preferably ignored in the secondary battery management system 100. As an ignoring method, a range corresponding to an irreversible change in the crystal structure is preferably determined in advance. In the case where an irreversible change in the crystal structure occurs in the vicinity of the upper limit voltage, the lower limit of the range is set −10%, preferably −8% of the upper limit voltage. Note that the upper limit of the range is the upper limit voltage.

Although the range is determined on the basis of the charging voltage in the above description, the lower limit of the range can be determined on the basis of the time corresponding to the charging voltage. The lower limit of the range can be determined on the basis of the quantity of electricity corresponding to the charging voltage.

A charging voltage at which an irreversible change in the crystal structure occurs may be grasped in advance by performing one or more cycles of charging and discharging on the secondary battery. The lower limit of the range can be −8%, preferably −5% of the charging voltage at which an irreversible change in the crystal structure occurs.

In the above range, the local maximum value is detected.

<d²Q/dV²>

At low temperatures, diffusion of carrier ions in a secondary battery, e.g., diffusion of lithium ions in a positive electrode active material and diffusion of lithium ions in a negative electrode active material are slow, and a phase change partly occurs; thus, the amount of change in dQ/dV is small in some cases. At this time, a clear local maximum value cannot be observed in dQ/dV. In such a case, the control circuit 153 preferably performs arithmetic operation of d²Q/dV². When the value of d²Q/dV² exceeds zero, the value of d²Q/dV² corresponds to the above-described local maximum value.

In the data showing the battery characteristics, a plurality of local maximum values are observed when reversible changes in the crystal structure are included, and thus the above-described case where the value of d²Q/dV² exceeds zero occurs a plurality of times. In the secondary battery management system 100, the time when the value of d²Q/dV² exceeds zero, which corresponds to one of the local maximum values corresponding to the start of an irreversible change in the crystal structure, is desired to be detected. For this reason, a local maximum value relating to a reversible crystal structure is preferably ignored in the secondary battery management system 100. As an ignoring method, a range corresponding to an irreversible change in the crystal structure is preferably determined in advance. In the case where an irreversible change in the crystal structure occurs in the vicinity of the upper limit voltage, the lower limit of the range is set −10%, preferably −8% of the upper limit voltage. Note that the upper limit of the range is the upper limit voltage.

Although the range is determined on the basis of the charging voltage in the above description, the lower limit of the range can be determined on the basis of the time corresponding to the charging voltage. The lower limit of the range can be determined on the basis of the quantity of electricity corresponding to the charging voltage.

A charging voltage at which an irreversible change in the crystal structure occurs may be grasped in advance by performing one or more cycles of charging and discharging on the secondary battery. The lower limit of the range can be −8%, preferably −5% of the charging voltage at which an irreversible change in the crystal structure occurs.

The time when the value of d²Q/dV² exceeds zero may be detected in the above range.

Example 1 or Example 2 of detecting a local maximum value can be selected depending on the temperature of the secondary battery.

### <Layered Rock-Salt Crystal Structure>

An active material having a layered rock-salt crystal structure is preferably used for a positive electrode or the like; the secondary battery management system 100 preferably grasps a change in the layered rock-salt crystal structure from the data showing the battery characteristics. For example, in the positive electrode active material having a layered rock-salt crystal structure, metals serving as carrier ions are arranged in a layered manner, and the carrier ions are extracted by charging, so that a change in the crystal structure, such as deviation of layers or a reduction in distance between layers, occurs. Such a change in the crystal structure is sometimes reversible and sometimes irreversible; thus, the control circuit 153 preferably detects a local maximum value corresponding to an irreversible state as described above.

### <Determination Function>

Owing to the determination function of the control circuit 153, the time at which the state corresponding to the local maximum value is obtained can be determined. Owing to the determination function, the voltage or the quantity of electricity of the secondary battery at the time at which the state corresponding to the local maximum value is obtained can also be determined.

### <Stop of Charging>

The control circuit 153 has a function of stopping charging on the basis of a detected local maximum value. The control circuit 153 can stop charging by utilizing information on the time linked to a local maximum value. The control circuit 153 can also stop charging by utilizing information on the quantity of electricity linked to a local maximum value.

In the case where the secondary battery management system 100 requires time to stop charging, the control circuit 153 can stop charging at the time after a predetermined time passes.

In this manner, the secondary battery management system 100 can determine the upper limit voltage by using the data showing the battery characteristics obtained from the secondary battery that is being used. The upper limit voltage can be determined in accordance with the data showing the battery characteristics, which is preferable particularly in the case where the secondary battery is used at low temperatures. The upper limit voltage is determined in this manner, whereby a secondary battery with high energy density can be obtained.

### <Charging Condition>

Constant current-constant voltage charging (CC-CV charging) is employed for charging of a secondary battery in some case. In CC-CV charging, constant current charging is performed up to the upper limit voltage of charging, and then, constant voltage charging is performed.

The charging condition from the start of charging to the stop of charging is preferably constant current charging. This is because, for example, even it takes time from determination of the upper limit voltage to the stop of charging, the upper limit voltage is not rapidly changed in the constant current charging period.

### <Coulomb Counter>

The charging circuit 101 preferably also has a function of a coulomb counter. For example, as a function of a coulomb counter, the charging circuit 101 can calculate the integrated quantity of electricity of the secondary battery 121 by using the current measuring circuit 152 and the control circuit 153. With the calculated quantity of electricity, the charge capacity and the discharge capacity of the secondary battery can be calculated.

### <SOC>

The control circuit 153 may have a function of analyzing the charge depth (SOC: State of Charge) using the calculated charge capacity and discharge capacity. The charge depth is one of indicators representing the charge rate, and SOC=100% means the fully charged state and SOC=0% means the completely discharged state. The control circuit 153 can determine the upper limit voltage on the basis of the charge depth.

### <Secondary Battery>

The details of the secondary battery 121 will be described later.

### Example 1 of Charging Method

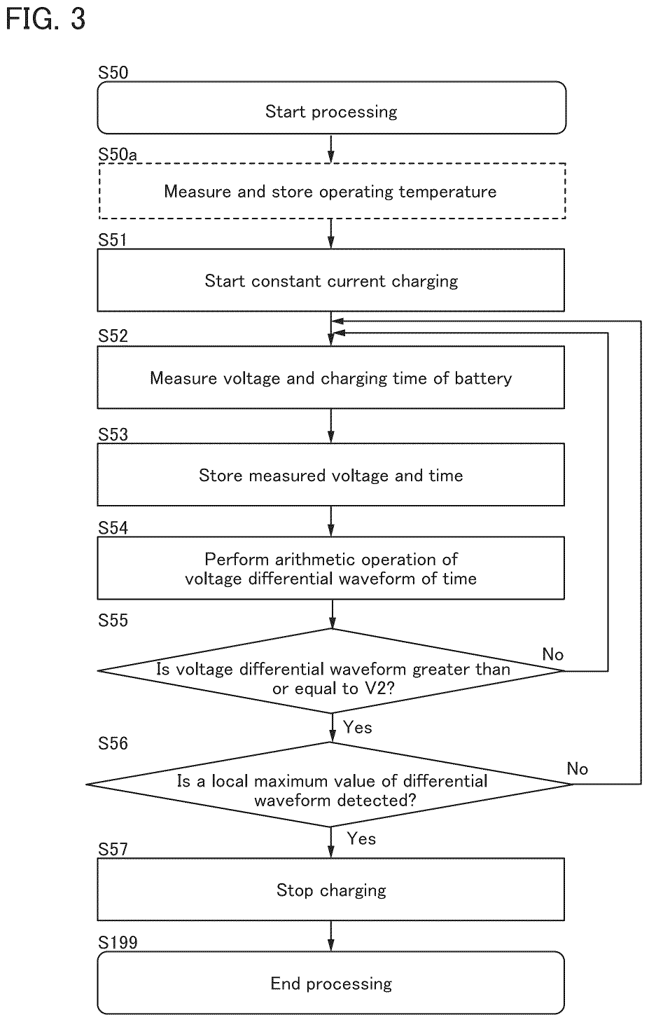

Next, an example of a charging method using the secondary battery management system 100 of one embodiment of the present invention is described with reference to a flowchart shown in FIG. 3.

First, processing starts in Step S50.

In the case where the secondary battery management system 100 includes a temperature sensor or the like, the temperature of the secondary battery, for example, the operating temperature is preferably measured and stored in the memory circuit 154 or the like in Step S50a. Since the value of overvoltage is different depending on temperature or the like, the temperature and the overvoltage can be linked to each other and stored. The temperature and the conditions of detecting a local maximum value may be linked and stored. The secondary battery management system 100 can employ such a linked value as information on temperature.

Next, in Step S51, constant current charging of the secondary battery is started. Note that the constant current charging is performed until the charging is stopped.

Next, in Step S52, the voltage measuring circuit 151 starts measurement of the voltage of the secondary battery. The control circuit 153 measures time using a clock signal or the like. In addition, the current measuring circuit 152 may start measurement of the current of the secondary battery.

Next, in Step S53, a voltage measured by the voltage measuring circuit 151 is stored in the memory circuit 154. A current measured by the current measuring circuit 152 is stored in the memory circuit 154. When the voltage and the current are analog values, the analog values may be converted to digital values and then stored in the memory circuit 154, and as an analog-digital converter circuit (ADC), the above-described one can be used.

As the time linked to the voltage, for example, time required from the start of charging, i.e., time elapsed from Step S50, may be used.

Next, in Step S54, the control circuit 153 performs an arithmetic operation of voltage differential waveform (dt/dV) of time using data set of measured voltage, current, and time. In the graph of dt/dV, the horizontal axis represents time t, the vertical axis represents a voltage differential dt/dV of time, and a curve is shown.

Next, in Step S55, only in the case where the measured voltage is higher than or equal to V2, the processing proceeds to Step S56. In the case where the voltage is lower than V2, the processing returns to Step S52 and the measurement is continued as shown in “No” in the chart. Here, the voltage V2 is a value lower than the above-described upper limit voltage by 10% (−10%), preferably a value lower than the above-described upper limit voltage by 8% (−8%); the voltage V2 is 4.5 V, or preferably 4.6 V when the upper limit voltage is 5 V.

Alternatively, determination in Step S55 may be performed on the basis of the charge depth of the secondary battery.

Next, in Step S56, the control circuit 153 analyzes dt/dV and detects a local maximum value. When a local maximum value cannot be detected, the control circuit 153 may perform averaging processing. When a local maximum value cannot be detected after the averaging processing, the control circuit 153 preferably obtains a change rate.

In the case where a local maximum value is not detected, the processing returns to Step S52 and the measurement is continued.

The control circuit 153 preferably repeats steps from Step S53 to Step S56 continuously to accumulate data set including at least voltage and time. That is, in the case where the steps from Step S53 to Step S56 are repeated n times (n is an integer greater than or equal to 2), the data showing the battery characteristics can be calculated using the values of n times of the measurement.

Next, in Step S57, after a local maximum value is detected in the data showing the battery characteristics, charging is stopped.

Although charging is stopped after a local maximum value is detected in Step S57, charging may be stopped after a local maximum value is detected and then a predetermined time elapses. This is because in a secondary battery using lithium cobalt oxide to be described later, even after a local maximum value is detected, an irreversible change in the crystal structure is not completed within a predetermined time. That is, after a local maximum value is detected, a period of a reversible change in the crystal structure remains until the predetermined time.

Here, information on the local maximum value detected in Step S56 may be used as the upper limit voltage in the next charge cycle. For example, the case where the steps from Step S51 to Step S56 are repeated s times is considered. Note that s is an integer greater than or equal to 2. In such a case, the charging may be stopped and time t1 and time t2 which are obtained on the basis of the local maximum value may be used for upper limit voltage in the next charge cycle.

Next, in Step S199, the processing ends.

The above description is an example in which the constant current charging is performed continuously in a period from the start of charging in Step S51 to the stop of charging in Step S57. At this time, the current value is set to constant in a period from the start of charging to the stop of charging.

The current value may be changed gradually in a period from the start of charging to the stop of charging. As a specific example, in the case where the steps from Step S52 to Step S56 are repeated a plurality of times, the current value may be set such that the current value in the second time is lower than the current value in the first time. Alternatively, the current value may be set such that the current value in the second time is higher than the current value in the first time.

In the secondary battery management system 100, a local maximum value is detected from the charge characteristics of the secondary battery, and charging conditions of the secondary battery can be changed in Step S57 in accordance with the detected local maximum value. The charge characteristics change depending on the environmental temperature of charging and discharging of the secondary battery, deterioration of the secondary battery due to charge and discharge cycles, and the like. The secondary battery management system 100 can inhibit the deterioration of the secondary battery by changing the charging conditions of the secondary battery, for example, a charging voltage or the like of the secondary battery, in accordance with the change in charge characteristics.

Furthermore, in the secondary battery management system 100, the local maximum value is detected from the charge characteristics, and the charging condition is changed in accordance with the detected local maximum value, whereby charging can be performed up to the limit in the range where the degradation of the secondary battery is inhibited.

### Example 2 of Charging Method

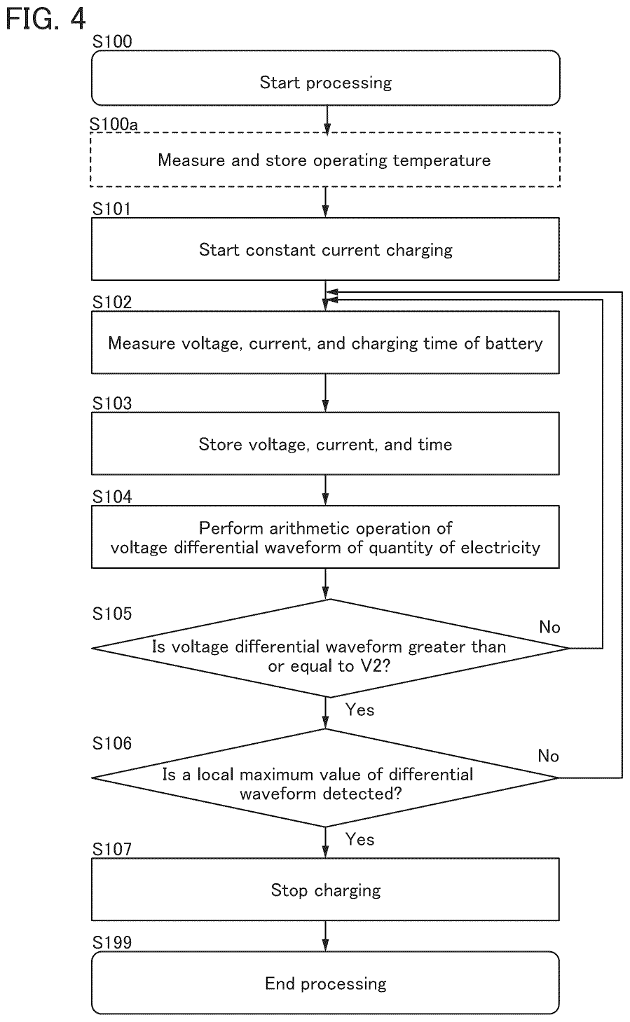

Next, an example of a charging method using the secondary battery management system 100 of one embodiment of the present invention is described with reference to a flowchart shown in FIG. 4.

First, processing starts in Step S100.

In the case where the secondary battery management system 100 includes a temperature sensor or the like, the temperature of the secondary battery, for example, the operating temperature is preferably measured and stored in the memory circuit 154 or the like in Step S50a.

Next, in Step S101, constant current charging of the secondary battery is started. Note that the constant current charging is performed until the charging is stopped.

Next, in Step S102, the voltage measuring circuit 151 starts measurement of the voltage of the secondary battery. In addition, the current measuring circuit 152 starts measurement of the current of the secondary battery. The control circuit 153 measures time using a clock signal or the like.

Next, in Step S103, a voltage measured by the voltage measuring circuit 151 is stored in the memory circuit 154. A current measured by the current measuring circuit 152 is stored in the memory circuit 154. When the voltage and the current are analog values, the analog values may be converted to digital values and then stored in the memory circuit 154, and as an analog-digital converter circuit (ADC), the above-described one can be used.

As the time linked to the voltage and the current, for example, time required from the start of charging, i.e., time elapsed from Step S100, may be used.

Next, in Step S104, the control circuit 153 performs an arithmetic operation of voltage differential waveform (dQ/dV) of electric quantity of the secondary battery using data set of measured voltage, current, and time. In the graph of dQ/dV, the horizontal axis represents voltage V, the vertical axis represents a voltage differential dQ/dV, and a curve is shown.

Next, in Step S105, only in the case where the measured voltage is higher than or equal to V2, the processing proceeds to Step S56. In the case where the voltage is lower than V2, the processing returns to Step S52 and the measurement is continued as shown in “No” in the chart. Here, the voltage V2 is a value lower than the above-described upper limit voltage by 10% (−10%), preferably a value lower than the above-described upper limit voltage by 8% (−8%); the voltage V2 is 4.5 V, or preferably 4.6 V when the upper limit voltage is 5 V.

Alternatively, determination in Step S105 may be performed on the basis of the charge depth of the secondary battery.

Next, in Step S106, the control circuit 153 analyzes dQ/dV and detects a local maximum value. When a local maximum value cannot be detected, the control circuit 153 preferably performs arithmetic operation of d²Q/dV². The state where the value of d²Q/dV² exceeds zero corresponds to the local maximum value.

In the case where a local maximum value is not detected, the processing returns to Step S102 and the measurement is continued.

The control circuit 153 preferably performs steps from Step S103 to Step S106 continuously without interruption to accumulate data set including at least voltage, current, and time. That is, in the case where the steps from Step S103 to Step S106 are repeated n times, the data showing the battery characteristics can be calculated using the values of n times of the measurement.

Next, in Step S107, after a local maximum value is detected in the data showing the battery characteristics, charging is stopped.

Although charging is stopped after a local maximum value is detected in Step S107, charging may be stopped after a local maximum value is detected and then a predetermined time elapses. This is because in a secondary battery using lithium cobalt oxide to be described later, even after a local maximum value is detected, an irreversible change in the crystal structure is not completed within a predetermined time. That is, after a local maximum value is detected, a period of a reversible change in the crystal structure remains until the predetermined time.

Here, information on the local maximum value detected in Step S106 may be used as the upper limit voltage in the next charge cycle. For example, the case where the steps from Step S101 to Step S106 are repeated s times is considered. Note that s is an integer greater than or equal to 2. In such a case, the charging may be stopped and time t1 and time t2 which are obtained on the basis of the local maximum value may be used for upper limit voltage in the next charge cycle.

Next, in Step S199, the processing ends.

The above description is an example in which the constant current charging is performed continuously in a period from the start of charging in Step S101 to the stop of charging in Step S107. At this time, the current value is set to constant in a period from the start of charging to the stop of charging.

The current value may be changed gradually in a period from the start of charging to the stop of charging. As a specific example, in the case where the steps from Step S102 to Step S106 are repeated a plurality of times, the current value may be set such that the current value in the second time is lower than the current value in the first time. Alternatively, the current value may be set such that the current value in the second time is higher than the current value in the first time.

In the secondary battery management system 100, a local maximum value is detected from the charge characteristics of the secondary battery, and charging conditions of the secondary battery can be changed in Step S107 in accordance with the detected local maximum value. The charge characteristics change depending on the environmental temperature of charging and discharging of the secondary battery, deterioration of the secondary battery due to charge and discharge cycles, and the like. The secondary battery management system 100 can inhibit the deterioration of the secondary battery by changing the charging conditions of the secondary battery, for example, a charging voltage or the like of the secondary battery, in accordance with the change in charge characteristics.

Furthermore, in the secondary battery management system 100, the local maximum value is detected from the charge characteristics, and the charging condition is changed in accordance with the detected local maximum value, whereby charging can be performed up to the limit in the range where the degradation of the secondary battery is inhibited.

<Control of Charging with Use of Temperature>

The charging circuit 101 preferably controls charging with use of temperature.

The control circuit 153 preferably changes charging conditions in accordance with the environmental temperature of the secondary battery measured by the temperature sensor 156. The environmental temperature is preferably low.

The memory circuit 154 included in the control circuit 153 preferably has a table in which the environmental temperature and charging conditions of the secondary battery are linked, for example.

In the memory circuit 154 included in the control circuit 153, charge characteristics linked to the environmental temperature of the secondary battery are preferably stored. The charge characteristics may be a past measured value of the secondary battery 121, a measured value of another secondary battery with similar characteristics, or a waveform obtained by calculation. In the flowcharts of FIG. 3 and FIG. 4, the local maximum value may be estimated by using such measurement values. Machine learning or the like can be used for the estimation, for example.

The control circuit 153 may use the charge characteristics of the secondary battery, which are stored in the memory circuit 154, for the analysis of the extrema (a local maximum value and a local minimum value) in the differential waveform of voltage and quantity of electricity. Here, for example, a capacity-voltage curve, a voltage-dQ/dV curve, a ΔV-t curve, impedance characteristics, or the like can be used as the charge characteristics.

### Example 2 of Secondary Battery Management System

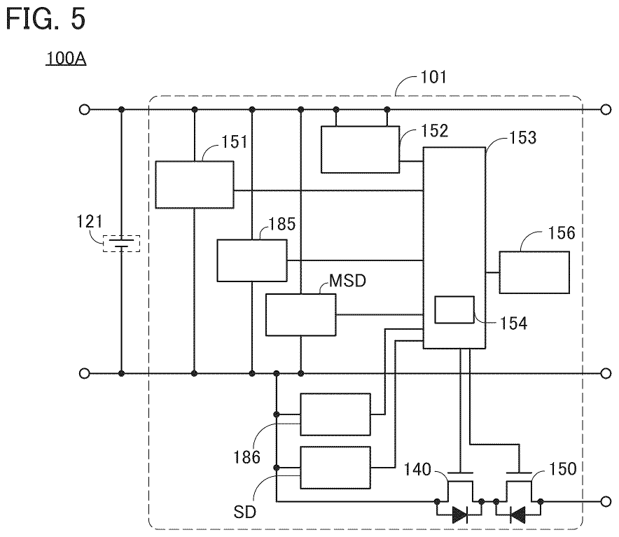

FIG. 5 illustrates an example of a secondary battery management system 100A. The secondary battery management system 100A can operate even at low temperatures.

The charging circuit 101 illustrated in FIG. 5 includes a sensing circuit or the like in addition to the components illustrated in FIG. 1B. An example is shown in which the sensing circuit or the like includes a detection circuit 185 having a function of detecting overcharge and overdischarge, a detection circuit 186 having a function of detecting charge overcurrent or discharge overcurrent, a short-circuit detection circuit SD, a micro-short-circuit detection circuit MSD, a transistor 140, and a transistor 150.

The charging circuit 101 illustrated in FIG. 5 has a function of inhibiting overcharge, overdischarge, charge overcurrent, discharge overcurrent, a short circuit, a micro-short circuit, and the like and can function as a protection circuit of the secondary battery. A micro-short circuit here refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. A large voltage change may occur in a relatively short time and a small area in some cases.

Transistors called power MOSFETs can be used as the transistor 140 and the transistor 150, for example.

The control circuit 153 has a function of blocking current flowing to the secondary battery 121 by supplying signals to gates of the transistor 140 and the transistor 150.

The detection circuit 185 monitors the voltage of the secondary battery, and when detecting overcharge or overdischarge, the detection circuit 185 can supply a signal of detection to the control circuit 153. The control circuit receives the signal and can supply a signal to at least one of the gate of the transistor 140 and the gate of the transistor 150, so that current flowing to the secondary battery can be blocked.

The detection circuit 186 monitors the current of the secondary battery, and when detecting an overcurrent in charging or discharging, the detection circuit 186 can supply a signal of detection to the control circuit 153. The control circuit receives the signal and can supply a signal to at least one of the gate of the transistor 140 and the gate of the transistor 150, so that current flowing to the secondary battery can be blocked.

The overcharge detected in the detection circuit 185 may be detected by using an extremum of the charging voltage change waveform over time or using an extremum of the differential waveform of voltage of quantity of electricity charged. Alternatively, the overcharge detected in the detection circuit 185 may be detected by comparison with a predetermined voltage value with use of a comparison circuit. The predetermined voltage value may be different depending on the environmental temperature of the secondary battery. The voltage value depending on the environmental temperature of the secondary battery is stored in the memory circuit 154 included in the control circuit 153, for example.

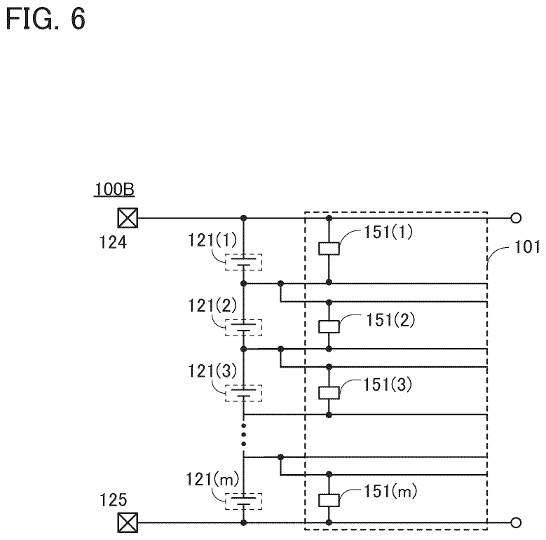

A secondary battery management system 100B illustrated in FIG. 6 is the secondary battery management system 100B including m secondary batteries 121 connected in series (m is an integer greater than or equal to 2).

The charging circuit 101 included in the secondary battery management system 100B is similar to that in FIG. 1A, FIG. 1B, FIG. 5, or the like. In the secondary battery management system 100B, the voltage measuring circuit measures a voltage of the corresponding secondary battery 121, and thus m voltage measuring circuits 151(m) are illustrated in accordance with the number of secondary batteries 121(m) in FIG. 6. Note that voltages of the secondary batteries 121 can be sequentially measured, and the number of voltage measuring circuits included in the charging circuit 101 can be smaller than the number of secondary batteries, for example, the number of voltage measuring circuits can be one.

In the secondary battery management system 100B, the detection circuit 185 included in the charging circuit 101 may detect overcharge at a voltage between a terminal 124 electrically connected to a positive electrode of the secondary battery 121(1) and a terminal 125 electrically connected to a negative electrode of the secondary battery 121(m). Moreover, for example, the detection circuit 186 and the short-circuit detection circuit SD included in the charging circuit 101 may detect overcharge or a short circuit on the basis of a current between the terminal 124 and the terminal 125.

The secondary battery management system 100B may independently control the charging circuits 101 connected to m secondary batteries 121. At this time, in the secondary battery 121 where charging is completed earlier among the m secondary batteries 121, a current is made to flow through a path that is connected in parallel to the secondary battery 121, for example, a transistor, a resistor, a diode, or the like connected in parallel to the secondary battery 121 after charging is completed. Thus, the charging circuit 101 preferably includes a switch for switching of a current path between the secondary battery 121 and the path.

In addition, the secondary battery management system 100B may control charging with use of the total of voltages of the m secondary batteries 121 (for example, in FIG. 6, a voltage between the positive electrode of the secondary battery 121(1) and the negative electrode of the secondary battery 121(m). In such a case, it is possible to use an m-fold voltage value as the voltage used for the control of charging.

### Example 3 of Secondary Battery Management System

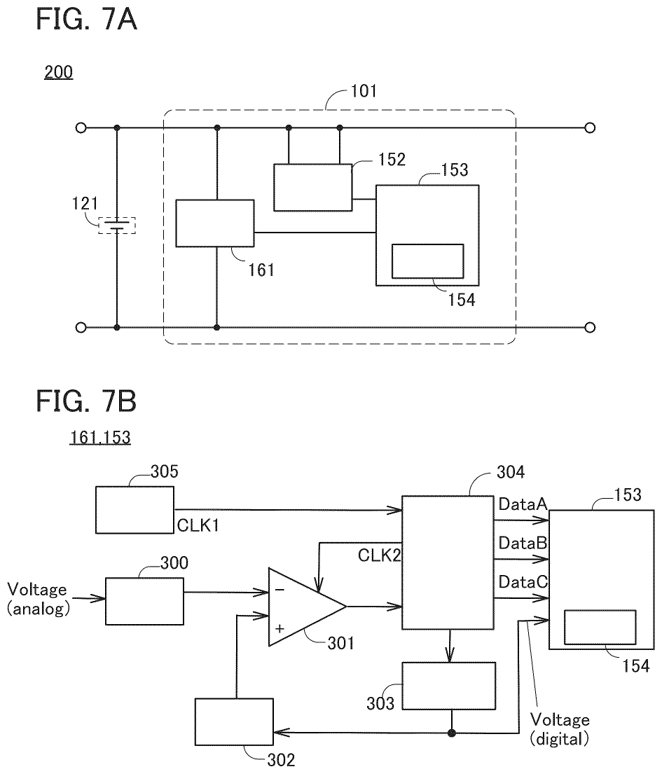

FIG. 7 illustrates an example of a secondary battery management system 200. The secondary battery management system 200 can operate even at low temperatures.

Unlike the structure illustrated in FIG. 1A, the charging circuit 101 illustrated in FIG. 7A includes a subtractor 161. The subtractor 161 has a function of outputting a time difference, and for example, the subtractor 161 can output a time difference when a difference occurs between the terminal voltage in the time t1 and the terminal voltage in the time t2. Furthermore, in addition to the above functions, the subtractor 161 has a function of converting an analog value to a digital value, that is, a function of an AD converter. Since the subtractor 161 has a voltage measurement function, the voltage measuring circuit 151 described in Example 1 and Example 2 can be omitted in Example 3, and the other components are similar to those in Example 1 and Example 2.

FIG. 7B illustrates the subtractor 161 and the control circuit 153. The subtractor 161 includes a sample-and-hold circuit 300, a comparator 301, a DA converter 302, a successive approximation register 303, a second control circuit 304, and a clock generation circuit 305. The subtractor 161 can include an AD converter, and the configuration of the AD converter can be any one of a double integrating type, a successive approximation type, a delta sigma type, a parallel comparison type (also referred to as a flash type), and a pipeline type. The number of bits of the successive approximation type AD converter can be greater than or equal to 10 and less than or equal to 18, and the conversion speed is greater than or equal to several tens of kHz and less than or equal to several MHz, which is preferable. The number of bits of the double integrating type AD converter can be greater than or equal to 8 and less than or equal to 20, and the conversion speed is greater than or equal to several Hz and less than or equal to several kHz, which is preferable.

The subtractor 161 can retain the obtained voltage (analog value) in the sample-and-hold circuit 300. In a period when an analog value is converted to a digital value, the value is preferably retained in the sample-and-hold circuit 300. As a transistor included in the sample-and-hold circuit 300, an OS transistor can be used. An OS transistor is a transistor in which an oxide semiconductor layer is used as an active layer.

For example, the off-state current value per micrometer of a channel width of an OS transistor at room temperature can be lower than or equal to 1 aA (1×10⁻¹⁸ A), lower than or equal to 1 zA (1×10⁻²¹ A), or lower than or equal to 1 yA (1×10⁻²⁴ A). Note that the off-state current value per micrometer of a channel width of a Si transistor at room temperature is higher than or equal to 1 fA (1×10⁻¹⁵ A) and lower than or equal to 1 pA (1×10⁻¹² A). Thus, the off-state current of the OS transistor can be said to be lower than the off-state current of the Si transistor by approximately ten orders of magnitude. Such a transistor with a low off-state current is suitable for the sample-and-hold circuit 300.

A value output from the sample-and-hold circuit 300 is input to the comparator 301, and is compared with data output from the successive approximation register 303. The successive approximation register 303 outputs digital data, which is obtained by dividing an analog value of voltage into at least two or more digital values. Each digital value is allocated to each bit. The digital data is converted from digital data to analog data through the DA converter 302 before being input to the comparator 301. In the comparator 301, the data from the sample-and-hold circuit 300 and the data from the successive approximation register 303 are compared. In the case where the two pieces of data match, 0 is output, and in the case where the two pieces of data do not match, 1 is output. The value of 0 or 1 is output to the second control circuit 304, and in the case where the two pieces of data match, a voltage (digital) is output from the successive approximation register 303. In this manner, the voltage converted into a digital value can be obtained.

Data DataA, data DataB, and data DataC are output from the second control circuit 304 to the control circuit 153. The data DataA is a sign (+ or −) representing charging or discharging, for example. The data DataB is count data regarding time, for example. The data DataC is a flag at error time. As an example of an error that should raise a flag, a case where a difference in voltage is allocated to 1 bit and determined to be two or more bits is given.

The subtractor 161 is preferably capable of outputting time between the time t1 and the time t2. Data corresponding to the time can be output by counting on the basis of a clock signal or the like input to the subtractor 161.

The subtractor 161 is preferably capable of outputting a positive or negative reference numeral. By the reference numeral, voltage at the time of charging and voltage at the time of discharging can be distinguished from each other. In the case where there is no need to distinguish the voltages, the reference numeral does not need to be output.

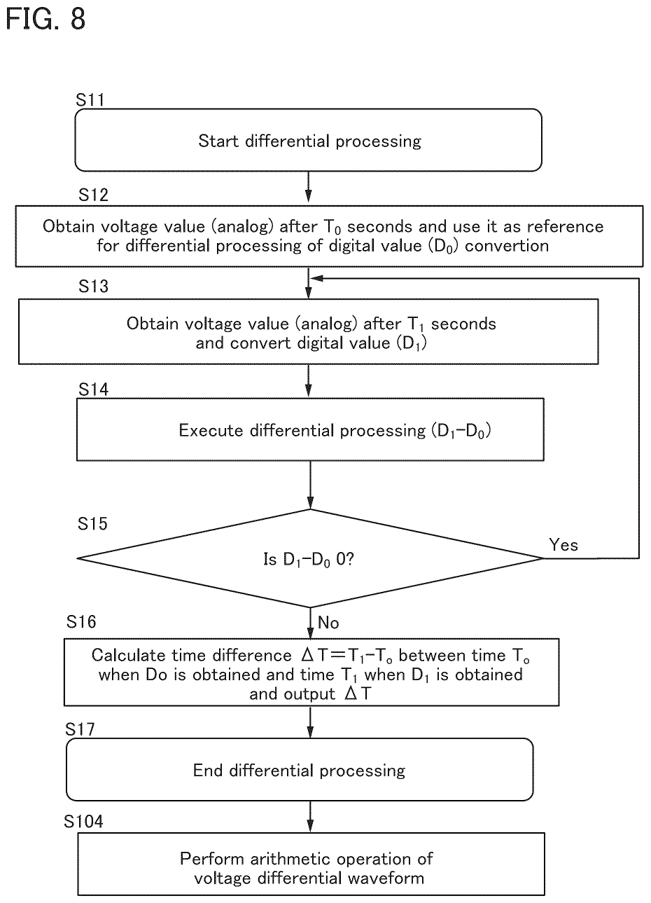

FIG. 8 is a flowchart relating to differential processing.

First, a differential processing starts in Step S11.

Next, in Step S12, an analog voltage value obtained in a given time T₀ can be converted to a digital value (D₀). The information on the obtained time is also added to the voltage value. For the conversion to a digital value, the above-described successive approximation type AD converter is preferably used. This digital value (D₀) is used as a reference for differential processing.

Next, in Step S13, an analog voltage value obtained after T₁ seconds from the given time is converted to a digital value (D₁). The information on the obtained time is also added to the voltage value. Although depending on the specifications of the management system, an interval of T seconds is greater than or equal to 50 ms and less than or equal to 1 s, preferably greater than or equal to 100 ms and less than or equal to 150 ms. The acquisition of the analog voltage is preferably performed periodically at the intervals mentioned above.

Next, in Step S14, subtraction processing is performed on the digital value (D₀) as a reference and the digital value (D₁) after T seconds, and subtraction processing is executed.

Next, in Step S15, whether the result of the subtraction processing is a value other than 0 is determined. In the case where the result is not 0 (corresponding to “No” in the chart), the processing proceeds to the next step; in the case where the result is 0 (corresponding to “Yes” in the chart), the processing returns to Step S13, a new voltage value is obtained and converted to a digital value, and then differential processing between the digital value and the digital value (D₀) as a reference voltage is repeated.

In the case where the result is not 0, the processing proceeds to Step S16, and a time difference (ΔT=T₁−T₀) is calculated and output.

After that, the differential processing is terminated in Step S17.

A graph relating to battery characteristics, such as a voltage differential waveform, is calculated on the basis of the time difference (ΔT), and steps up to the stop of charging are performed as shown in FIG. 3 and the like.

This embodiment can be combined with the description of the other embodiments as appropriate.

### Embodiment 2

In this embodiment, an example of a secondary battery of one embodiment of the present invention will be described. A secondary battery of one embodiment of the present invention preferably includes a positive electrode, a negative electrode, and an electrolyte.

### <Positive Electrode>

The positive electrode of one embodiment of the present invention contains a positive electrode active material.

### [Positive Electrode Active Material]

The positive electrode active material contains lithium, a transition metal M, oxygen, and an additive element A. Alternatively, the positive electrode active material can contain a composite oxide containing lithium and the transition metal M (LiMO₂) into which the additive element A is added. Note that the composition of the composite oxide is not strictly limited to Li:M:O=1:1:2. In some cases, a positive electrode active material to which the additive element A is added is referred to as a composite oxide.

It is preferable that the positive electrode active material of one embodiment of the present invention mainly contain cobalt as the transition metal M taking part in an oxidation-reduction reaction. In addition to cobalt, at least one or two or more selected from nickel and manganese may be contained. When cobalt is used as the transition metal M contained in the positive electrode active material at greater than or equal to 75 atomic %, preferably greater than or equal to 90 atomic %, further preferably greater than or equal to 95 atomic %, many advantages such as relatively easy synthesis, easy handling, and excellent cycle performance are gained, which is preferable.

When cobalt is used as the transition metal M contained in the positive electrode active material at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal M, such as lithium nickel oxide (LiNiO₂).

Using nickel at greater than or equal to 33 at %, preferably greater than or equal to 60 at %, further preferably greater than or equal to 80 at % as the transition metal M contained in the positive electrode active material is preferable because in that case, the cost of the raw materials might be lower than that in the case of using a large amount of cobalt and charge and discharge capacity per weight might be increased.

As the additive element A contained in the positive electrode active material, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements A is preferably less than 25 atomic %, further preferably less than 10 atomic %, still further preferably less than 5 atomic %

That is, the positive electrode active material can contain lithium cobalt oxide to which magnesium and fluorine are added; lithium cobalt oxide to which magnesium, fluorine, and titanium are added; lithium cobalt oxide to which magnesium, fluorine, and aluminum are added; lithium cobalt oxide to which magnesium, fluorine, and nickel are added; lithium cobalt oxide to which magnesium, fluorine, nickel, and aluminum are added; or the like.

Such additive elements A can further stabilize a crystal structure included in the positive electrode active material.

There is no need to contain all elements described as the additive element A, and for example, a positive electrode active material that is substantially free from manganese can be employed. The positive electrode active material that is substantially free from manganese enhances the above advantages such as relatively easy synthesis, easy handling, and excellent cycle performance. In the positive electrode active material that is substantially free from manganese, the weight of manganese is preferably less than or equal to 600 ppm, further preferably less than or equal to 100 ppm. The weight of manganese can be analyzed by GD-MS, for example.

### <Crystal Structure>

In this specification and the like, the remaining amount of lithium that can be inserted into and extracted from a positive electrode active material is represented by x in a compositional formula, e.g., x in LiₓCoO₂ or x in LiₓMO₂. In this specification, LiₓCoO₂ can be replaced with LiₓMO₂ as appropriate. In the case of a positive electrode active material in a secondary battery, x can be (theoretical capacity-charge capacity)/theoretical capacity. For example, when a secondary battery using LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x≤0.24.

Lithium cobalt oxide to be used for a positive electrode, which has been appropriately synthesized and almost satisfies the stoichiometric proportion, is LiCoO₂, and the occupancy rate x of Li in the lithium sites is 1. For a secondary battery after its discharging ends, it can be said that lithium cobalt oxide is LiCoO₂ and x=1. Here, “discharging ends” means that a voltage becomes lower than or equal to 2.5 V (lithium counter electrode) at a current of 100 mA/g, for example.

<<x in LiₓCoO₂ being 1>>

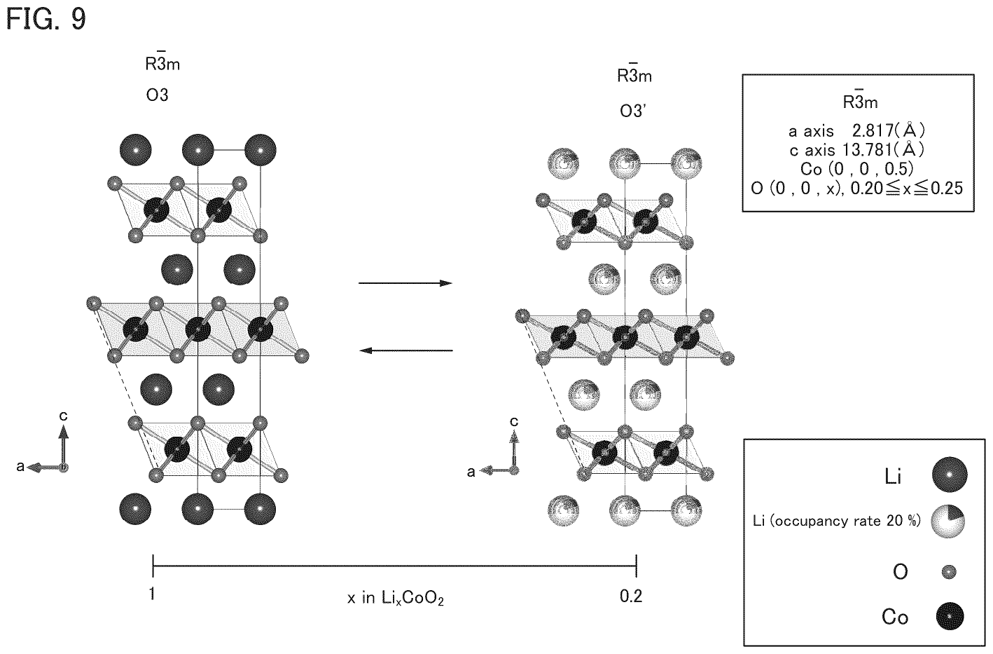

The positive electrode active material of one embodiment of the present invention preferably has a layered rock-salt crystal structure belonging to the space group R-3m in the case where x in LiₓCoO₂ is 1 as shown in FIG. 9. In the case where x in LiₓCoO₂ is 1, the positive electrode active material is in a discharging state. A composite oxide having the layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is particularly preferable that an inner portion, which accounts for the majority of the volume of the positive electrode active material, have a layered rock-salt crystal structure.

The surface portion is a region including the additive element A and can function as a barrier film of the positive electrode active material. A surface portion refers to, for example, a region that is within 50 nm, preferably within 35 nm, further preferably within 20 nm, most preferably within 10 nm in depth from a surface of a positive electrode active material toward an inner portion.

A surface portion is a region from which lithium ions are extracted first in charge, and is a region that tends to have a lower lithium concentration than the inner portion. Thus, the surface portion is regarded as a region that tends to be unstable and tends to start deterioration of the crystal structure. Meanwhile, when the surface portion can be made sufficiently stable, the layered structure, which is formed of octahedrons of a transition metal M and oxygen, of the inner portion is unlikely to be broken even with small x in LiₓCoO₂, e.g., with x of less than or equal to 0.24. Furthermore, a shift in layers, which are formed of octahedrons of the transition metal M and oxygen, of the inner portion can be inhibited.

In order that the surface portion can have a stable composition and a stable crystal structure, the surface portion preferably contains an additive element A, further preferably contains a plurality of additive elements A. The surface portion preferably has a higher concentration of one or more selected from the additive elements A than the inner portion. The one or more selected from the additive elements A contained in the positive electrode active material preferably have a concentration gradient. In addition, it is further preferable that the additive elements A in the positive electrode active material be differently distributed. For example, it is further preferable that the additive elements A exhibit concentration peaks at different depths from a surface. The concentration peak here refers to the local maximum value of the concentration.

For example, magnesium, which is one of the additive elements A, is divalent, and magnesium is likely to be present in lithium sites than in transition metal M sites in the layered rock-salt crystal structure. An appropriate concentration of magnesium in the lithium sites of the surface portion facilitates maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material. In addition, when a magnesium concentration in the surface portion is high, it is expected that the corrosion resistance to hydrofluoric acid generated by the decomposition of the electrolyte solution is improved.

The entire positive electrode active material preferably contains an appropriate amount of magnesium. For example, the proportion of magnesium to the transition metal M (the sum of the transition metals when the transition metal M is a plurality of transition metals) (Mg/M) contained in the positive electrode active material of one embodiment of the present invention is preferably higher than or equal to 0.25% and lower than or equal to 5%, further preferably higher than or equal to 0.5% and lower than or equal to 2%, still further preferably approximately 1%. The amount of magnesium contained in the entire positive electrode active material here may be a value obtained by element analysis on the entire positive electrode active material using GD-MS, ICP-MS, or the like, or may be a value based on the ratio of the raw materials mixed in the formation process of the positive electrode active material, for example.

Nickel, which is one of the additive elements A, can exist in both the transition metal M site and the lithium site. Nickel preferably exists in the transition metal M site because an oxidation-reduction potential can be is lower than the case of cobalt, leading to an increase in discharge capacity.

In addition, when nickel exists in the lithium site, a shift in the layer structure, which is formed of the transition metal M and octahedrons of oxygen, can be inhibited. Moreover, a change in the volume in charging and discharging is inhibited. Furthermore, an elastic modulus becomes large, i.e., hardness increases. This is probably because nickel in the lithium sites also serves as a column supporting the CoO₂ layers. Therefore, in particular, the crystal structure is expected to be more stable in a charged at high temperatures, e.g., 45° C. or higher, which is preferable.

The entire positive electrode active material preferably contains an appropriate amount of nickel. For example, the number of nickel atoms contained in the positive electrode active material is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the formation process of the positive electrode active material, for example.

Aluminum, which is one of additive elements A, can exist in the transition metal M site in a layered rock-salt crystal structure. Since aluminum is a trivalent representative element and its valence does not change, lithium around aluminum is less likely to move even in charging and discharging. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond; thus, extraction of oxygen around aluminum can be inhibited. These effects improve thermal stability. Hence, when aluminum is included as the additive element A, a secondary battery including the positive electrode active material can have improved stability. Furthermore, the positive electrode active material can have a crystal structure that is less likely to be broken by repeated charging and discharging.

The entire positive electrode active material preferably contains an appropriate amount of aluminum. For example, the number of aluminum atoms contained in the entire positive electrode active material is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The amount contained in the entire positive electrode active material here may be a value obtained by element analysis on the entire positive electrode active material using GD-MS, ICP-MS, or the like, or may be a value based on the ratio of the raw materials mixed in the formation process of the positive electrode active material, for example.

Fluorine, which is one of the additive elements A, is a monovalent anion; when fluorine is substituted for part of oxygen in the surface portion, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion of the positive electrode active material, lithium ions near fluorine are likely to be extracted and inserted smoothly. Thus, the use of the positive electrode active material in a secondary battery can improve the charge and discharge characteristics, current characteristics, and the like. When fluorine exists in the surface portion, which has a surface in contact with the electrolyte solution, the corrosion resistance to hydrofluoric acid can be effectively improved. As will be described in the embodiment below, when a fluoride such as lithium fluoride has a lower melting point than another additive element A source, the fluoride can serve as a fusing agent (also referred to as a flux) for lowering the melting point of the another additive element A source.

An oxide of titanium, which is one of the additive elements A, is known to have superhydrophilicity. Accordingly, the positive electrode active material that contains titanium oxide in the surface portion presumably has good wettability with respect to a high-polarity solvent. In a secondary battery formed using the positive electrode active material, the positive electrode active material and a high-polarity electrolyte solution can have favorable contact at the interface therebetween, which may inhibit an internal resistance increase.

When the surface portion contains phosphorus, which is one of the additive elements A, a short circuit can be inhibited while a state with small x in LiₓCoO₂ is maintained, in some cases, which is preferable. For example, a compound containing phosphorus and oxygen preferably exists in the surface portion.

When the positive electrode active material contains phosphorus, phosphorus may react with hydrogen fluoride generated by the decomposition of the electrolyte solution or the electrolyte, which might be able to decrease the hydrogen fluoride concentration in the electrolyte and is preferable.

In the case where the electrolyte contains LiPF₆, hydrogen fluoride might be generated by hydrolysis. Furthermore, hydrogen fluoride might be generated by the reaction of polyvinylidene fluoride (PVDF) used as a component of the positive electrode and alkali. The decrease in hydrogen fluoride concentration in the electrolyte can inhibit corrosion of a current collector and/or separation of the coating film in some cases. Furthermore, a reduction in adhesion properties due to gelling and/or insolubilization of PVDF can be inhibited in some cases.

Note that it is not preferable that the surface portion be occupied by only a compound of the additive element A and oxygen because it becomes difficult to insert and extract lithium. For example, it is not preferable that the surface portion be occupied by only MgO, a structure in which MgO and NiO(II) form a solid solution, and/or a structure in which MgO and CoO(II) form a solid solution. Thus, the surface portion needs to contain at least cobalt, and also contain lithium in a discharged state to have the path through which lithium is inserted and extracted.

To ensure the sufficient path through which lithium is inserted and extracted, the concentration of cobalt is preferably higher than that of magnesium in the surface portion. For example, an atomic ratio of the number of magnesium atoms Mg to the number of cobalt atoms Co, Mg/Co, is preferably less than or equal to 0.62. The concentration of cobalt is preferably higher than that of nickel in the surface portion. The concentration of cobalt is preferably higher than that of aluminum in the surface portion. The concentration of cobalt is preferably higher than that of fluorine in the surface portion.

<<The State where x in LiₓCoO₂ is Small>>

A change in the crystal structure due to the change in x in LiₓCoO₂ is described with reference to FIG. 9.

The crystal structure in a state where x in LiₓCoO₂ is small of the positive electrode active material of one embodiment of the present invention is different from that of a conventional positive electrode active material because the positive electrode active material has the above-described distribution and/or crystal structure of the additive element A in a discharged state. Here, “x is small” means 0.1<x≤0.24.

In the positive electrode active material of one embodiment of the present invention shown in FIG. 9, a change in the crystal structure between a discharged state with x in LiₓCoO₂ being 1 and a state with x being 0.24 or less is smaller than that in a conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material of one embodiment of the present invention can have a crystal structure that is difficult to break even when charging that makes x be 0.24 or less and discharging are repeated, and enables excellent cycle performance. In addition, the positive electrode active material of one embodiment of the present invention with x in LiₓCoO₂ being 0.24 or less can have a more stable crystal structure than a conventional positive electrode active material. Thus, the positive electrode active material of one embodiment of the present invention with x in LiₓCoO₂ being kept at 0.24 or less inhibits a short circuit. This is preferable because the safety of the secondary battery is improved.

FIG. 9 shows crystal structures of an inner portion of the positive electrode active material in a state where x in LiₓCoO₂ is 1 and in a state where x in LiₓCoO₂ is approximately 0.2. The inner portion, accounting for the majority of the volume of the positive electrode active material, largely contributes to charging and discharging and is accordingly a portion where a shift in CoO₂ layers and a volume change matter most.

The positive electrode active material with x being 1 has the R-3m 03 type crystal structure, which is the same as that of conventional lithium cobalt oxide.

However, the positive electrode active material has a crystal structure different from the H1-3 type crystal structure when x is 0.24 or less, e.g., approximately 0.2 or approximately 0.12, with which conventional lithium cobalt oxide has the H1-3 type crystal structure.

The positive electrode active material of one embodiment of the present invention with x being approximately 0.2 has a trigonal crystal structure belonging to the space group R-3m. The symmetry of the CoO₂ layers of this structure is the same as that of O₃. Thus, this crystal structure is called an O3′ type crystal structure. In FIG. 9, this crystal structure is denoted by R-3m O3′.

In the unit cell of the O3′ type crystal structure, the coordinates of cobalt and oxygen can be represented as follows: Co (0, 0, 0.5) and O (0, 0, x) within the range of 0.20≤x≤0.25. In the unit cell, the lattice constant of the a-axis is preferably 0.2797≤a≤0.2837 (nm), further preferably 0.2807≤a≤0.2827 (nm), typically a=0.2817 (nm). The lattice constant of the c-axis is preferably 1.3681≤c≤1.3881 (nm), further preferably 1.3751≤c≤1.3811 (nm), typically, c=1.3781 (nm).

The positive electrode active material whose crystal structure when being charged at 25° C. is represented by the O3′ type crystal structure, has a diffraction intensity maximum at 20=19.35±0.10° and 2θ=45.55±0.20° in some cases when the positive electrode active material in the charge state is analyzed by powder X-ray analysis using CuKα1 radiation.

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 9, the CoO₂ layers hardly shift between the R-3m (O3) in a discharged state and the O3′ type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

As described above, in the positive electrode active material of one embodiment of the present invention, a change in the crystal structure caused when x in LiₓCoO₂ is small, i.e., when a large amount of lithium is extracted, is smaller than that in a conventional positive electrode active material. In addition, a change in the volume between the compared structures having the same number of cobalt atoms is inhibited. Thus, the crystal structure of the positive electrode active material is unlikely to be broken even when charge and discharge are repeated so that x becomes less than or equal to 0.24. This inhibits a decrease in charge and discharge capacity of the positive electrode active material in charge and discharge cycles. Furthermore, the positive electrode active material can stably use a larger amount of lithium than a conventional positive electrode active material and thus has high discharge capacity per weight and per volume. Hence, with the use of the positive electrode active material, a secondary battery with high discharge capacity per weight and per volume can be fabricated.

Note that the positive electrode active material is confirmed to have the O3′ type crystal structure in some cases when x in LiₓCoO₂ is greater than or equal to 0.15 and less than or equal to 0.24, and is presumed to have the O3′ type crystal structure even when x is greater than 0.24 and less than or equal to 0.27. However, the crystal structure is influenced not only by x in LiₓCoO₂ but also by the number of charge and discharge cycles, charge and discharge current, temperature, an electrolyte, and the like; thus, the range of x is not limited to the above.

Thus, when x in LiₓCoO₂ is greater than 0.1 and less than or equal to 0.24, the entire internal structure of the positive electrode active material is not necessarily the O3′ type crystal structure. The positive electrode active material either may include another crystal structure or may be partly amorphous.

In order to make x in LiₓCoO₂ small, charge at a high charge voltage is necessary in general. Thus, a state where x in LiₓCoO₂ is small can be rephrased as a state where charge at a high charge voltage has been performed. For example, when CC/CV charge is performed at 25° C. and 4.6 V or higher with reference to the potential of a lithium metal, the H1-3 type crystal structure appears in a conventional positive electrode active material. Hence, a charge voltage of 4.6 V or higher can be regarded as a high charge voltage with reference to the potential of a lithium metal. In this specification and the like, unless otherwise specified, charge voltage is shown with reference to the potential of a lithium metal.

Thus, the positive electrode active material of one embodiment of the present invention is preferable because the crystal structure with the symmetry of R-3m 03 can be maintained even when charge at a high charge voltage of 4.6 V or higher is performed at 25° C., for example. Moreover, the positive electrode active material of one embodiment of the present invention is preferable because the O3′ type crystal structure can be obtained when charge at a higher charge voltage, e.g., a voltage higher than or equal to 4.65 V and lower than or equal to 4.7 V, is performed at 25° C.

At a much higher charge voltage, the H1-3 type crystal is eventually observed also in the positive electrode active material in some cases. As described above, the crystal structure is influenced by the number of charge and discharge cycles, charge and discharge current, an electrolyte, and the like; thus, the positive electrode active material of one embodiment of the present invention sometimes has the O3′ type crystal structure even at a lower charge voltage, e.g., a charge voltage higher than or equal to 4.5 V and lower than 4.6 V, at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

### [Formation Method of Positive Electrode Active Material]

A way of adding the additive element A is important in forming the positive electrode active material having the distribution of the additive element A, the composition, and/or the crystal structure described in the above embodiment. Favorable crystallinity of the inner portion is important as well.

Therefore, in the fabrication process of the positive electrode active material, it is preferable that a composite oxide containing lithium and a transition metal be synthesized first, and then the additive element A source be mixed and heat treatment be performed.

In a method of synthesizing a composite oxide containing the additive element A, lithium, and the transition metal M by mixing the additive element A source concurrently with the transition metal M source and a lithium source, it is sometimes difficult to increase the concentration of the additive element A in the surface portion. In addition, after a composite oxide containing lithium and the transition metal M is synthesized, only mixing the additive element A source without performing heating causes the additive element A to be just attached to, not dissolved in, the composite oxide containing lithium and the transition metal M. It is difficult to distribute the additive element A favorably without sufficient heating. Therefore, it is preferable that lithium cobalt oxide be synthesized, and then the additive element A source be mixed and heat treatment be performed. The heat treatment after mixing of the additive element A source may be referred to as annealing.

However, annealing at an excessively high temperature may cause cation mixing, which increases the possibility of entry of the additive element A such as magnesium into the transition metal M sites. Magnesium that exists at the transition metal M sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be sublimated or evaporated.

In view of the above, a material functioning as a fusing agent is preferably mixed together with the additive element A source. The material can be regarded as functioning as a fusing agent when having a melting point lower than that of the composite oxide containing lithium and the transition metal M. As a material functioning as a fusing agent, a fluorine compound such as lithium fluoride is suitably used. Adding the fusing agent decreases the melting points of the additive element A source and the composite oxide containing lithium and the transition metal M. The decrease in the melting point makes it easier to favorably distribute the additive element A at a temperature where the cation mixing is less likely to occur.

It is further preferable that heat treatment be performed between the synthesis of the composite oxide containing lithium and the transition metal M and the mixing of the additive element A. This heating is referred to as initial heating in some cases.

Owing to influence of lithium extraction from part of the surface portion of the composite oxide containing lithium and the transition metal M by the initial heating, the distribution of the additive element A becomes more favorable.

Specifically, the distributions of the additive elements A can be easily made different from each other by the initial heating in the following mechanism. First, lithium is extracted from part of the surface portion by the initial heating. Next, the additive element A sources such as a nickel source, an aluminum source, and a magnesium source and the composite oxide containing lithium and the transition metal M including the surface portion that is deficient in lithium are mixed and heated. Among the additive elements A, magnesium is a divalent representative element, and nickel is a transition metal but is likely to be a divalent ion. Therefore, in part of the surface portion, a rock-salt phase containing Co²⁺, which is reduced due to lithium deficiency, Mg²⁺, and Ni²⁺ is formed.

Among the additive elements A, nickel is likely to form a solid solution and is diffused to the inner portion in the case where the surface portion is a composite oxide containing lithium and the transition metal M and having a layered rock-salt crystal structure, but nickel is likely to remain in the surface portion in the case where part of the surface portion has a rock-salt crystal structure.

Furthermore, in such a rock-salt crystal structure, the bond distance between a metal Me and oxygen (Me-O distance) tends to be longer than that in a layered rock-salt crystal structure. For example, Me-O distance is 0.209 nm and 0.211 nm in Ni_{0.5}Mg_{0.5}O having a rock-salt crystal structure and MgO having a rock-salt crystal structure, respectively. Even when a spinel phase is formed in part of the surface portion, Me-O distance is 0.20125 nm and 0.202 nm in NiAl₂O4 having a spinel structure and MgAl₂O4 having a spinel structure, respectively. In each case, Me-O distance is longer than 0.2 nm.

Meanwhile, in a layered rock-salt crystal structure, the bond distance between oxygen and a metal other than lithium is shorter than the above distance. For example, Al—O distance is 0.1905 nm (Li—O distance is 0.211 nm) in LiAlO₂ having a layered rock-salt crystal structure. In addition, Co—O distance is 0.19224 nm (Li—O distance is 0.20916 nm) in LiCoO₂ having a layered rock-salt crystal structure.

According to the ionic radius of Shannon (Shannon, R. D. Acta Crystallogr. 1976, A 32, 751), the ion radius of hexacoordinated aluminum and the ion radius of hexacoordinated oxygen are 0.0535 nm and 0.14 nm, respectively, and the sum of those values is 0.1935 nm.

From the above, aluminum is considered to exist at sites other than lithium sites more stably in a layered rock-salt crystal structure than in a rock-salt crystal structure. Thus, in the surface portion, aluminum is more likely to be distributed in a region having a layered rock-salt phase at a larger depth and/or the inner portion than in a region having a rock-salt phase that is close to the surface.

Moreover, the initial heating is expected to increase the crystallinity of the layered rock-salt crystal structure of the inner portion.

However, the initial heating is not necessarily performed. In some cases, by controlling atmosphere, temperature, time, or the like in another heating step, e.g., annealing, the positive electrode active material having the O3′ type structure when x in LiₓCoO₂ is small can be fabricated.

### Example 1 of Method for Forming Positive Electrode Active Material

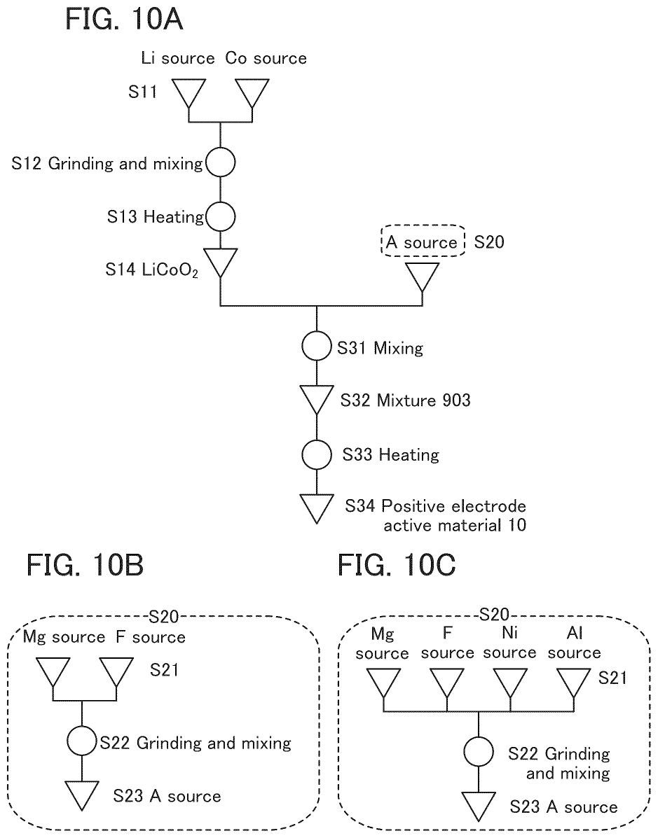

An example of a method for forming the positive electrode active material that can be used as one embodiment of the present invention (Example 1 of method for forming positive electrode active material) is be described with reference to FIG. 10A to FIG. 10C. Note that the formation method described here is an example of a method for forming the positive electrode active material 10 having characteristics that have been already described in this embodiment.

### <Step S11>

In Step S11 shown in FIG. 10A, a lithium source (Li source) and a cobalt source (Co source) are prepared as materials for lithium and the transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide, cobalt hydroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity, and preferably includes single crystal particles, for example. To evaluate the crystallinity of the cobalt source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the cobalt source.

### <Step S12>

Next, in Step S12 shown in FIG. 10A, the lithium source and the cobalt source are ground and mixed to form a mixed material (mixture). The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 10A, the above mixed material is heated. The heating temperature is preferably higher than or equal to 800° C. and lower than or equal to 1100° C., further preferably higher than or equal to 900° C. and lower than or equal to 1000° C., still further preferably higher than or equal to 950° C. and lower than or equal to 1000° C. An excessively low temperature might lead to insufficient decomposition and melting of the lithium source and the cobalt source. An excessively high temperature might lead to a defect due to evaporation of lithium from the lithium source and/or excessive reduction of the metal used as the cobalt source, for example. For example, an oxygen defect which could be induced by a change of trivalent cobalt into divalent cobalt.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. The crucible made of aluminum oxide has a material property that hardly releases impurities. In this embodiment, a crucible made of aluminum oxide with a purity of 99.9% is used. The heating is preferably performed with the crucible covered with a lid, in which case volatilization of a material can be prevented.

The heated material is ground as needed and may be made to pass through a sieve. Before collection of the heated material, the material may be moved from the crucible to a mortar. As the mortar, a mortar made of aluminum oxide or zirconium oxide is suitably used. A mortar made of aluminum oxide has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized in Step S14 in FIG. 10A.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S20>

Next, as shown in Step S20, the additive element A is preferably added as the A source to the lithium cobalt oxide. Next, details of Step S20 of preparing the additive element A as the A source are described with reference to FIG. 10B and FIG. 10C.

### <Step S21>

Step S20 shown in FIG. 10B includes Step S21 to Step S23. In Step S21, the additive element A is prepared. As the additive element A, the additive element X and the additive element Y described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or more selected from bromine and beryllium can be used. FIG. 10B shows an example of the case where a magnesium source and a fluorine source are prepared. Note that in Step S21, a lithium source may be separately prepared in addition to the additive element A.

When magnesium is selected as the additive element A, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. Meanwhile, when the proportion of lithium fluoride increases, the cycling performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the expression “an approximate value of a given value” means greater than 0.9 times and less than 1.1 times the given value, unless otherwise specified.

### <Step S22>

Next, in Step S22 shown in FIG. 10B, the magnesium source and the fluorine source are ground and mixed. Any of the conditions for grinding and mixing that are described for Step S12 can be selected to perform this step.

Here, a heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### <Step S23>

Next, in Step S23 shown in FIG. 10B, the materials ground and mixed in the above step are collected to obtain the additive element A source (A source). Note that the additive element A source in Step S23 contains a plurality of starting materials and can be referred to as a mixture.

As for the particle diameter of the mixture, the D50 (median diameter) is preferably greater than or equal to 600 nm and less than or equal to 20 μm, further preferably greater than or equal to 1 μm and less than or equal to 10 μm. Also when one kind of material is used as the additive element A source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the additive element) is easily attached to the surface of lithium cobalt oxide uniformly in a later step of mixing with the lithium cobalt oxide. The mixture is preferably attached uniformly to the surface of the lithium cobalt oxide, in which case the additive element is easily distributed or dispersed uniformly in the surface portion of the composite oxide after heating.

### <Step S21>

A process different from that in FIG. 10B is described with reference to FIG. 10C. Step S20 shown in FIG. 10C includes Step S21 to Step S23.

In Step S21 shown in FIG. 10C, four kinds of additive element sources to be added to the lithium cobalt oxide are prepared. In other words, FIG. 10C is different from FIG. 10B in the kinds of the additive element sources. A lithium source may be separately prepared in addition to the additive element sources.

As the four kinds of added element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 10B. As a nickel source, nickel oxide, nickel hydroxide, or the like can be used. As an aluminum source, aluminum oxide, aluminum hydroxide, or the like can be used.

### <Step S22 and Step S23>

Next, Step S22 and Step S23 shown in FIG. 10C are similar to the steps described with reference to FIG. 10B.

### <Step S31>

Next, in Step S31 shown in FIG. 10A, the lithium cobalt oxide and the additive element X are mixed. The atomic ratio of cobalt Co in the lithium cobalt oxide to magnesium Mg contained in the additive element (A source) is preferably Co:Mg=100:y (0.1≤y≤6), further preferably M:Mg=100:y (0.3≤y≤3).

The condition of the mixing in Step S31 is preferably milder than that of the mixing in Step S12 not to damage the lithium cobalt oxide shape. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 of FIG. 10A, the materials mixed in the above manner are collected to obtain a mixture 903. At the time of the collection, the materials may be crushed as needed and made to pass through a sieve.

Note that the method is not limited that in FIG. 10A to FIG. 10C. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Step S11 to Step S14 and Step S21 to Step S23. This method can be regarded as being simple and highly productive.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 10A, the mixture 903 is heated. Any of the heating conditions described for Step S13 can be selected. The heating time is preferably longer than or equal to 2 hours. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Note that the reaction more easily proceeds at a temperature higher than or equal to the temperature at which one or more selected from the materials contained in the mixture 903 are melted. For example, in the case where LiF and MgF₂ are included in the added element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits a local maximum value of endothermic temperature (sometimes referred to as an endothermic temperature local maximum value) at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step S13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and fabrication of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Thus, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

When the median diameter (D50) of the lithium cobalt oxide in Step S14 in FIG. 10A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 10A, in which crushing is performed as needed; thus, the positive electrode active material 10 is obtained. Here, the collected positive electrode active material 10 is preferably made to pass through a sieve. Through the above steps, the positive electrode active material 10 having the features described in this embodiment can be formed.

### Example 2 of Method for Forming Positive Electrode Active Material

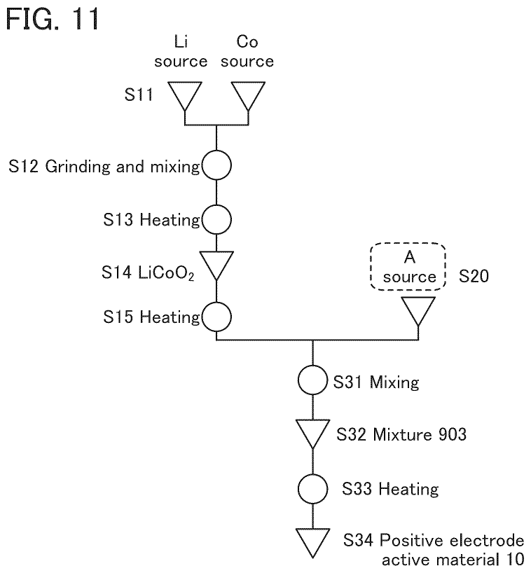

Another example of a method for forming the positive electrode active material that can be used as one embodiment of the present invention (Example 2 of method for forming positive electrode active material) is described with reference to FIG. 11.

Steps S11 to S14 in FIG. 11 are performed as in FIG. 10A to prepare lithium cobalt oxide.

### <Step S15>

Next, in Step S15 shown in FIG. 11, the lithium cobalt oxide is heated. The heating in Step S15 is the heating performed on the lithium cobalt oxide, and thus is sometimes referred to as the initial heating. The heating is performed before Step S20 described below; and thus is sometimes referred to as preheating or pretreatment.

By the initial heating, lithium is extracted from part of the surface portion of the lithium cobalt oxide as described above. In addition, an effect of increasing the crystallinity of the inner portion can be expected. The lithium source and/or lithium cobalt oxide source prepared in Step S11 and the like might contain impurities. The initial heating can reduce impurities in the lithium cobalt oxide completed in Step 14. Note that the effect of increasing the crystallinity of the internal portion is, for example, an effect of reducing distortion, a shift, or the like derived from differential shrinkage or the like of the lithium cobalt oxide formed in Step S13.

Through the initial heating, an effect of smoothing the surface of the lithium cobalt oxide is obtained. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, a lithium compound source, an additive element source, or a material functioning as a fusing agent is not necessary to be separately prepared.

When the heating time in this step is too short, a sufficient effect is not obtained, but when the heating time in this step is too long, the productivity is lowered. For example, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The heating in Step S13 might cause a temperature difference between the surface and an inner portion of the above lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the lithium cobalt oxide smooth.

Such differential shrinkage might cause a micro shift in the lithium cobalt oxide such as a shift in a crystal. To reduce the shift, this step is preferably performed. To reduce the shift, the heating in Step S15 is preferably performed. Performing Step S15 can distribute a shift uniformly in the composite oxide (reduce the shift in a crystal or the like which is caused in the composite oxide or align crystal grains). As a result, the surface of the composite oxide may become smooth.

In a secondary battery including lithium cobalt oxide with a smooth surface as a positive electrode active material, deterioration by charging and discharging is suppressed and a crack in the positive electrode active material can be prevented.

Note that in Step S14, lithium cobalt oxide synthesized in advance may be used. In this case, Step S11 to Step S13 can be omitted. When Step S15 is performed on the pre-synthesized lithium cobalt oxide, lithium cobalt oxide with a smooth surface can be obtained.

After that, in FIG. 11, the positive electrode active material 10 in Step S34 is obtained by performing Steps S20 to S33 as in FIG. 10A. Note that FIG. 10B and FIG. 10C can be referred to for the details of Step S20 in FIG. 11. Through the above steps, the positive electrode active material 10 having the features described in this embodiment can be formed.

### Example 3 of Method for Forming Positive Electrode Active Material

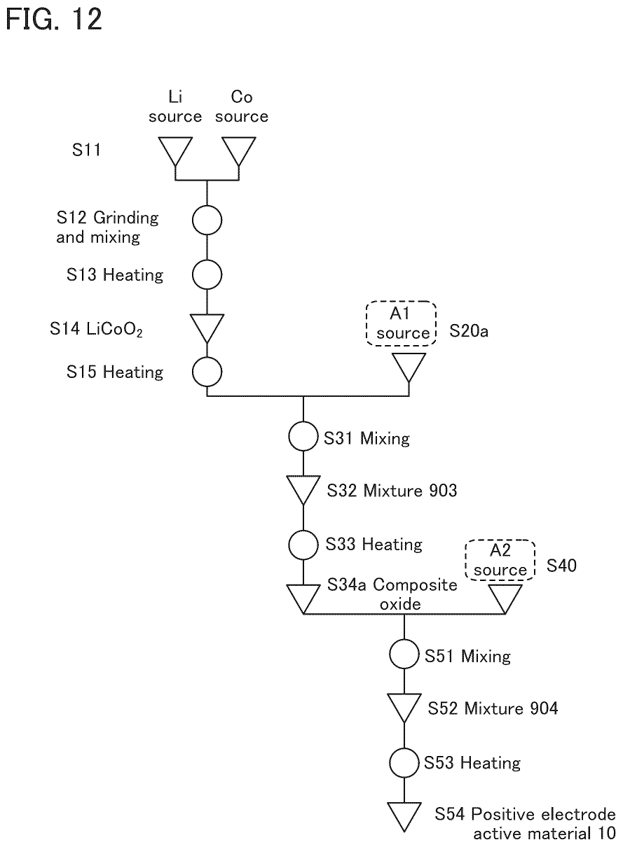

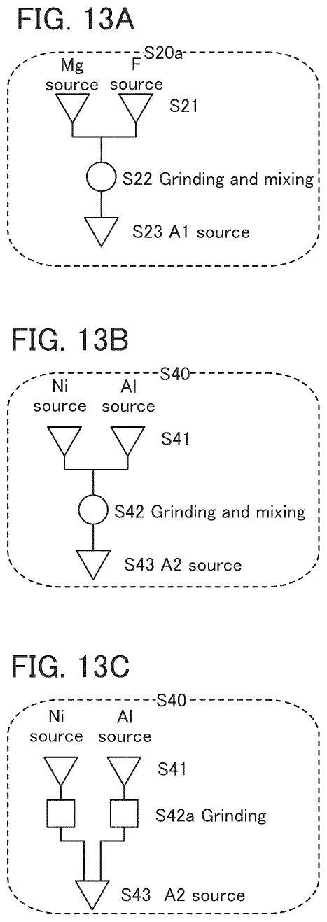

Another example of a method for forming the positive electrode active material that can be used as one embodiment of the present invention (Example 3 of method for forming positive electrode active material) is described with reference to FIG. 12 and FIG. 13. Although Example 3 of method for forming positive electrode active material is different from Example 1 and Example 2 of method for forming positive electrode active material described above in the number of times of adding the additive element and a mixing method, for the description except for the above, the description of Example 1 and Example 2 of method for forming positive electrode active material can be referred to.

Steps S11 to S15 in FIG. 12 are performed as in FIG. 10A to prepare lithium cobalt oxide that has been subjected to the initial heating.

### <Step S20a>

Next, as shown in Step S20a, the additive element A is preferably added to the lithium cobalt oxide that has been subjected to the initial heating. Step S20a is described with reference to FIG. 13A.

### <Step S21>

In Step S21 shown in FIG. 13A, a first additive element source (A1 source) is prepared. The A1 source can be selected from the additive elements A described for Step S21 with reference to FIG. 10B to be used. For example, one or more selected from magnesium, fluorine, and calcium can be used as the additive element A1. FIG. 13A shows an example of the case where a magnesium source (Mg source) and a fluorine source (F source) are used as the additive element A1.

Step S21 to Step S23 shown in FIG. 13A can be performed under the same conditions as those in Step S21 to Step S23 shown in FIG. 10B. As a result, the additive element source (A1 source) can be obtained in Step S23.

Steps S31 to S33 shown in FIG. 12 can be performed under the same conditions as those in Steps S31 to S33 shown in FIG. 10A.

### <Step S34a>

Next, the material heated in Step S33 is collected to form lithium cobalt oxide containing the additive element A1. Here, this composite oxide is called a second composite oxide to be distinguished from the composite oxide (a first composite oxide) in Step S14.

### <Step S40>

In Step S40 shown in FIG. 12, a second additive element source is added. Step S40 is described with reference to FIG. 13B and FIG. 13C.

### <Step S41>

In Step S41 shown in FIG. 13B, the second additive element source (A2 source) is prepared. The A2 source can be selected from the above-described additive elements A described for Step S21 shown in FIG. 10B. For example, one or more selected from nickel, titanium, boron, zirconium, and aluminum can be suitably used as the additive element A2. FIG. 13B shows an example of the case where nickel and aluminum are used as the additive element A2.

Step S41 to Step S43 shown in FIG. 13B can be performed under the same conditions as those in Step S21 to Step S23 shown in FIG. 10B. As a result, the additive element source (A2 source) can be obtained in Step S43.

FIG. 13C showing Step S41 to Step S43 is a variation example of FIG. 13B. A nickel source (Ni source) and an aluminum source (A1 source) are prepared in Step S41 shown in FIG. 13C and are separately ground in Step S42a. Accordingly, a plurality of the second additive element sources (42 sources) are prepared in Step S43. FIG. 13C is different from FIG. 13B in separately grinding the additive elements in Step S42a.

### <Step S51 to Step S53>

Next, Step S51 to Step S53 shown in FIG. 12 can be performed under the same conditions as those in Step S31 to Step S33 shown in FIG. 10A. The heating in Step S53 can be performed under such condition as a lower temperature and a shorter time than those of the heating in Step S33.

### <Step S54>

Next, the heated material is collected in Step S54 shown in FIG. 12, in which crushing is performed as needed; thus, the positive electrode active material 10 is obtained. Through the above steps, the positive electrode active material 10 having the features described in this embodiment can be formed.

As shown in FIG. 12 and FIG. 13, in the formation method 2, introduction of the additive element to the lithium cobalt oxide is divided into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

### <Negative Electrode>

A negative electrode of one embodiment of the present invention includes a negative electrode active material.

As the negative electrode active material, a material that can react with carrier ions of a secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Carbon materials such as graphite, graphitizing carbon, non-graphitizing carbon, carbon nanotube, carbon black, and graphene can be used as the negative electrode active material, for example.

In addition, a material containing one or more elements selected from silicon, lithium, tin, gallium, aluminum, germanium, lead, antimony, bismuth, silver, zinc, cadmium, and indium can be used as the negative electrode active material, for example.

An impurity element such as phosphorus, arsenic, boron, aluminum, or gallium may be added to silicon so that silicon is lowered in resistance.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

The analysis of the compound containing silicon can be performed by NMR, XRD, a Raman spectroscopy method, or the like.

As a negative electrode containing lithium, lithium foil is prepared. Lithium foil can be formed by a sputtering method, a CVD method, or an evaporation method and is referred to as a lithium layer or a lithium metal in some cases.

Furthermore, an oxide containing one or more elements selected from titanium, niobium, tungsten, and molybdenum can be used as a material that can be used for the negative electrode active material, for example.

As the negative electrode active material, it is possible to use a combination of two or more of the aforementioned metals, materials, compounds, and the like.

The negative electrode active material of one embodiment of the present invention may contain fluorine in a surface portion. When the negative electrode active material contains halogen in its surface portion, a decrease in charge and discharge efficiency can be inhibited. Moreover, it is considered that a reaction with an electrolyte at a surface of the active material is inhibited. In addition, at least part of the surface of the negative electrode active material of one embodiment of the present invention is covered with a region containing halogen in some cases. The region may have a film shape, for example. Fluorine is particularly preferable as halogen.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-particle-based solid electrolyte, an oxide-based solid electrolyte, or a polymer-based solid electrolyte can be used, for example. In particular, the polymer-based solid electrolyte can be uniformly formed as a film over the negative electrode current collector relatively easily, and thus is suitable for the film for making lithium deposition uniform. Moreover, as the film for making lithium deposition uniform, for example, a metal film that forms an alloy with lithium can be used. As the metal film that forms an alloy with lithium, for example, a magnesium metal film can be used. Lithium and magnesium form a solid solution in a wide range of compositions, and thus is suitable for the film for making lithium deposition uniform.

In the case where the negative electrode that does not contain a negative electrode active material is used, a negative electrode current collector having unevenness can be used. In the case where the negative electrode current collector having unevenness is used, a depression of the negative electrode current collector becomes a cavity in which lithium contained in the negative electrode current collector is easily deposited, so that the lithium can be inhibited from having a dendrite-like shape when being deposited.

### <Electrolyte>

The electrolyte preferably contains a solvent and a metal salt serving as a carrier ion. When a carrier ion is a lithium ion, a salt of a metal is referred to as a lithium salt. As the solvent of the electrolyte, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

The solvent of the electrolyte contains ethylene carbonate (EC), ethyl methyl carbonate (EMC), and dimethyl carbonate (DMC). When a total content of the ethylene carbonate, the ethyl methyl carbonate, and the dimethyl carbonate is set to 100 vol %, an organic solvent in which the volume ratio between ethylene carbonate, ethyl methyl carbonate, dimethyl carbonate is x:y:100-x-y (where 5≤x≤35 and 0<y<65) can be used. More specifically, an organic solvent containing EC, EMC, and DMC at EC:EMC:DMC=30:35:35 (volume ratio) can be used.

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the organic solvent. Then, the organic solvent specifically described in one embodiment of the present invention preferably includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte formed using a mixed organic solvent in a volume ratio of x:y:100-x-y (note that 5≤x≤35 and 0<y<65) with a total content of these three organic solvents of EC, EMC, and DMC having such physical properties of 100 vol % has a characteristic in which the freezing point is lower than or equal to −40° C., which is preferable.

Alternatively, the use of one or more ionic liquids (room temperature molten salts) that are less likely to burn and volatize as the solvent of the electrolyte can prevent a secondary battery from exploding and igniting even when the secondary battery causes an internal short circuit or the temperature of the internal region increases owing to overcharging or the like. An ionic liquid contains a cation and an anion, specifically, an organic cation and an anion. Examples of the organic cation used for the electrolyte include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As a salt dissolved in the above-described solvent, one of lithium salts such as LiPF₆, LiClO₄, LiASF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte used for a secondary battery is preferably a highly purified electrolyte solution that contains few dust particles and elements other than the constituent elements of the electrolyte (hereinafter, also simply referred to as impurities). Specifically, the weight ratio of impurities to the electrolyte is preferably less than or equal to 1%, further preferably less than or equal to 0.1%, still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte. The concentration of the material to be added in the whole solvent is, for example, higher than or equal to 0.1 wt % and lower than or equal to 5 wt %. It is particularly preferable to use VC or LiBOB because it facilitates film formation.

A solution containing a solvent and a salt serving as a carrier ion is referred to as an electrolyte solution in some cases.

A polymer gel electrolyte obtained in a manner in which a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO), PVDF, polyacrylonitrile, and a copolymer containing any of them. For example, PVDF-HFP, which is a copolymer of PVDF and hexafluoropropylene (HFP), can be used. The formed polymer may be porous.

As the electrolyte, a solid electrolyte including an inorganic material can be used. For example, a sulfide-based solid electrolyte, an oxide-based solid electrolyte, a halide-based solid electrolyte, or the like can be used. Alternatively, a solid electrolyte containing a high-molecular material such as a PEO (polyethylene oxide)-based high-molecular material can be used. When the solid electrolyte is used, a separator and/or a spacer is/are not necessary. Furthermore, the battery can be entirely solidified; therefore, there is no possibility of liquid leakage and thus the safety of the battery is dramatically improved.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₋ₓAlₓTi₂₋ₓ (PO₄)₃), a material having a garnet crystal structure (e.g., Li₇La₃Zr₂O₁₂), a material having a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte. Alternatively, different solid electrolytes may be mixed and used.

In particular, Li₁₊ₓAlₓTi₂₋ₓ(PO₄)₃ (0[x[1) having a NASICON crystal structure (hereinafter, LATP) is preferable because LATP contains aluminum and titanium, each of which is the element the positive electrode active material used in the secondary battery of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(AO₄)₃ (M: transition metal; A:S, P, As, Mo, W, or the like) and has a structure in which MO₆ octahedra and AO₄ tetrahedra that share common corners are arranged three-dimensionally.

### <Voltage of Secondary Battery>

When the secondary battery includes a compound represented by the chemical formula LiCoO₂ as a positive electrode active material, and graphite at 70 or higher percent by weight as a negative electrode active material, the charging voltage of charge of the secondary battery is preferably higher than 4.2 V, further preferably higher than 4.3 V. In addition, the charging voltage of the secondary battery is 4.8 V or lower, 4.7 V or lower, or 4.65 V or lower, for example.

When the secondary battery includes a compound represented by the chemical formula LiMO₂ where 40 or higher mole percent of M is nickel, as a positive electrode active material, and graphite at 70 or higher percent by weight as a negative electrode active material, the charging voltage of the secondary battery is preferably 4.1 v or higher, further preferably 4.2 V or higher. In addition, the charging voltage of the secondary battery is 4.8 V or lower, 4.7 V or lower, or 4.65 V or lower, for example.

### <Capacity of Secondary Battery>

In charging with use of the charging circuit of one embodiment of the present invention, the charge capacity is preferably higher than or equal to 200 mAh/g, further preferably higher than or equal to 210 mAh/g, still further preferably higher than or equal to 215 mAh/g (at 45° C., the charge rate of 0.5 C) per weight of the positive electrode active material.

This embodiment can be combined with the description of the other embodiments as appropriate.

### Embodiment 3

In this embodiment, examples of embodiments of the secondary battery applicable to the secondary battery management system of one embodiment of the present invention will be described.

### <Laminated Secondary Battery>

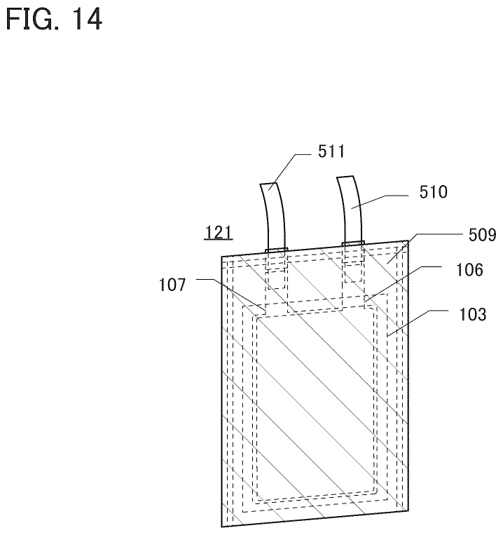

FIG. 14 illustrates an example of an external view of a laminated secondary battery 121. In FIG. 14, the positive electrode layer 106, the negative electrode layer 107, the separator 103, an exterior body 509, a positive electrode lead electrode 510, and a negative electrode lead electrode 511 are included.

### <Method of Fabricating Laminated Secondary Battery>

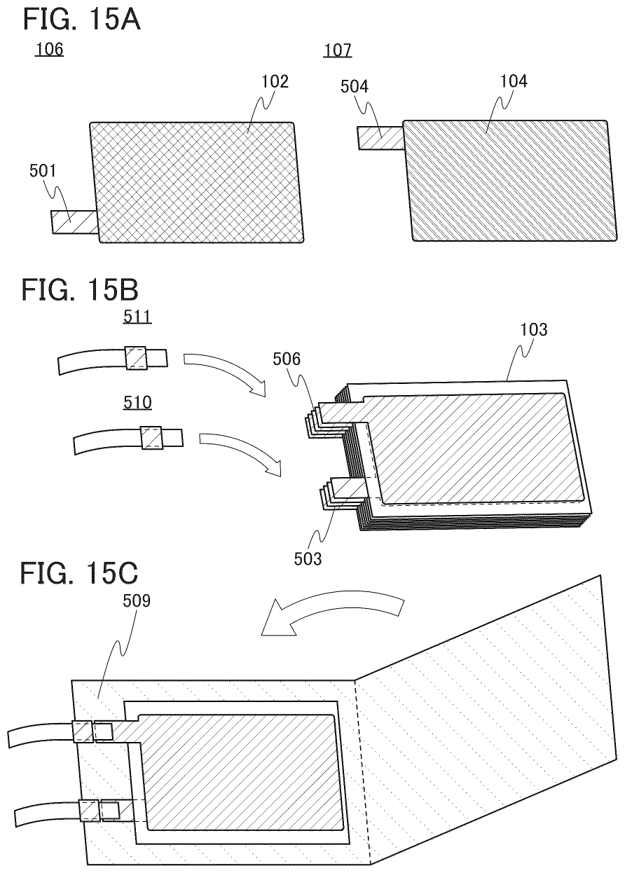

An example of a method for fabricating the laminated secondary battery whose external view is illustrated in FIG. 14 will be described with reference to FIG. 15A to FIG. 15C.

FIG. 15A illustrates external views of the positive electrode layer 106 and the negative electrode layer 107. The positive electrode layer 106 has a structure in which a positive electrode active material layer is formed in a positive electrode current collector. The positive electrode layer 106 includes a region where the positive electrode current collector is partly exposed (hereinafter referred to as a tab region), and a positive electrode tab 501 is provided in the region. The negative electrode layer 107 has a structure in which a negative electrode active material layer is formed in a negative electrode current collector. The negative electrode layer 107 includes a region where the negative electrode current collector is partly exposed, that is, a tab region, and a negative electrode tab 504 is provided in the region.

As illustrated in FIG. 15B, the negative electrode layer 107, the separator 103, and the positive electrode layer 106 are stacked. Here, an example in which five negative electrodes and four positive electrodes are used is shown. Next, the tab regions of the positive electrode layers 106 are bonded to each other, and the positive electrode lead electrode 510 is bonded to the tab region of the positive electrode on the outermost surface. The bonding is performed by ultrasonic welding, for example. In a similar manner, the tab regions of the negative electrode layers 107 are bonded to each other, and the negative electrode lead electrode 511 is bonded to the tab region of the negative electrode on the outermost surface.

Next, as illustrated in FIG. 15C, the stack illustrated in FIG. 15B is placed over the exterior body 509, and the exterior body 509 is folded along a dashed line. After that, the outer edges of the exterior body 509 are bonded to each other. The region used for the bonding is referred to as a bonding region. The bonding can be performed by thermocompression, for example.

Next, an electrolyte solution can be injected into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 121 can be fabricated.

This embodiment can be used in combination with any of the other embodiments.

### Embodiment 4

In this embodiment, an example of an embodiment of the secondary battery described in the above embodiment will be described.

The above-described laminated secondary battery 121 can be bent, for example. That is, the secondary battery 121 has flexibility.

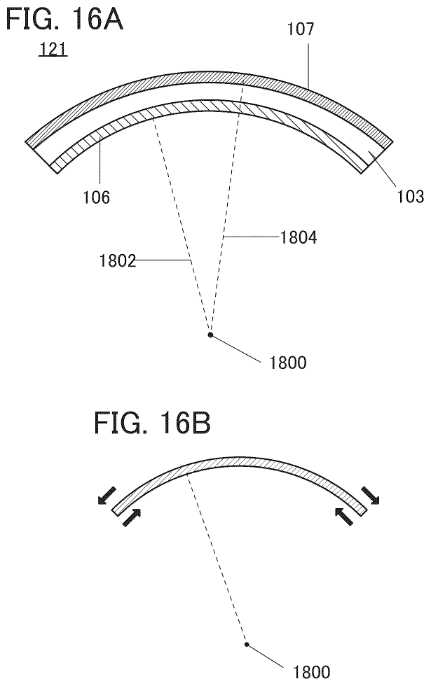

FIG. 16A illustrates the secondary battery 121 in a state of being bent. FIG. 16A illustrates a state where the secondary battery 121 including the positive electrode layer 106, the separator 103, and the negative electrode layer 107 is bent to the positive electrode layer 106 side. It is needless to say that the secondary battery 121 can be in a state of being bent to the negative electrode layer 107 side. Note that the state of being bent includes a state where a cross section of the secondary battery 121 has a shape including an arc-like portion.

Although an exterior body is not illustrated in FIG. 16A, the secondary battery 121 includes an exterior body, for example. The exterior body described in the above embodiment can follow a curved shape.

Next, the state of being bent is described in detail. As illustrated in FIG. 16A, in the secondary battery 121, a radius 1802 of curvature of a layer closer to a center 1800 of curvature, e.g., the positive electrode layer 106, is smaller than a radius 1804 of curvature of a layer farther from the center 1800 of curvature, e.g., the negative electrode layer 107. For easy bending, a layer whose radius of curvature is small, e.g., the positive electrode layer 106, preferably has a smaller thickness than the negative electrode layer 107.

When the secondary battery 121 is bent as illustrated in FIG. 16A, compressive stress is applied to the surface of the positive electrode layer 106 and tensile stress is applied to the surface of the negative electrode layer 107 as indicated by arrows in FIG. 16B. To reduce the compressive stress, a layer whose radius of curvature is small, e.g., the positive electrode layer 106, may have a larger thickness than the negative electrode layer 107.

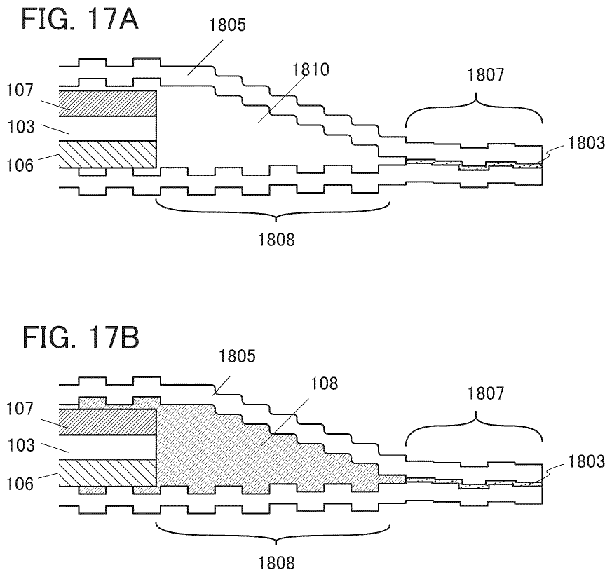

A structure in which an exterior body is provided with depressions and projections will be described as an embodiment for reducing the compressive stress and the tensile stress with reference to FIG. 17A and FIG. 17B.

Depressions and projections are formed on the surface of an exterior body 1805 and look like a pattern. As is observed in a cross section of the exterior body 1805, when the exterior body is provided with projections, depressions are formed at the same time, and when the exterior body is provided with depressions, projections are formed at the same time. That is, it is not necessary to form both depressions and projections on the exterior body because when either of them is formed, the other is formed at the same time.

The exterior body 1805 can reduce the compressive stress and the tensile stress. That is, the secondary battery 121 can change its shape within a range in which the radius of curvature of the exterior body on a side closer to the center of curvature is greater than or equal to 30 mm, preferably greater than or equal to 10 mm.

An end portion of the exterior body 1805 illustrated in FIG. 17A and FIG. 17B has a bonding region 1807. The bonding region 1807 is a region where the exterior bodies 1805 are bonded by thermocompression bonding or the like. In the bonding region 1807, an adhesive layer 1803 is preferably positioned between the exterior bodies 1805.

In the bonding region 1807, depressions or projections provided above and below the exterior bodies 1805 preferably overlap with each other. Since the depressions or the projections overlap with each other, depressions or projections may be additionally formed on the exterior bodies 1805 when the exterior bodies are bonded. Such a structure can increase the bonding strength.

FIG. 17A illustrates the secondary battery 121 in which a space 1810 is in a region 1808, which is in the end portion of the exterior body 1805 and is not the bonding region 1807.

FIG. 17B illustrates the secondary battery 121 in which an electrolyte solution 108 is in the region 1808, which is in the end portion of the exterior body 1805 and is not the bonding region 1807. Since the adhesion of the exterior body 1805 is high, the electrolyte solution 108 does not leak from the exterior body 1805. Note that the region 1808 in FIG. 17B sometimes has a structure including a space when being not filled with the electrolyte solution 108.

The shape of the secondary battery 121 in a state of being bent in a cross-sectional view is not limited to a simple arc shape and may be a shape partly including an arc.

This embodiment can be used in combination with any of the other embodiments.

### Embodiment 5

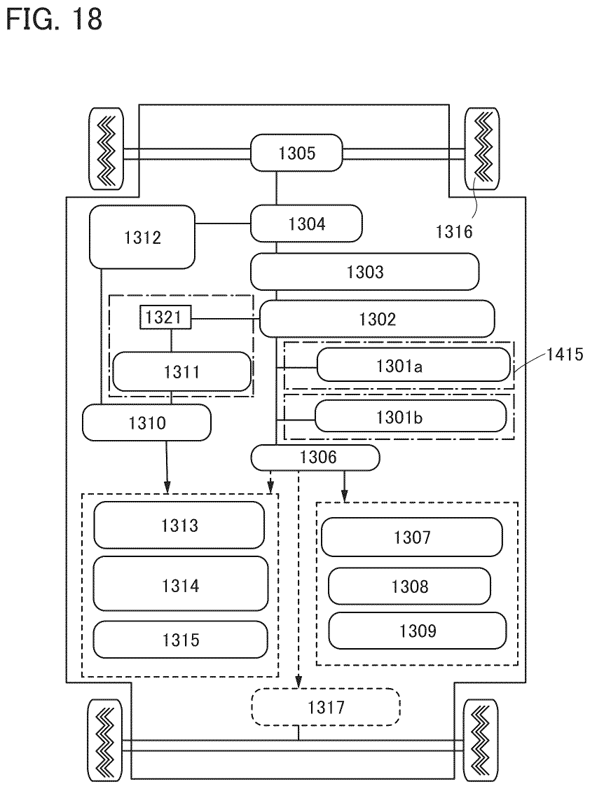

In this embodiment, application examples of the secondary battery management system of one embodiment of the present invention will be described with reference to FIG. 18 to FIG. 23.

In an application example below, the secondary battery management system preferably includes the charging circuit of one embodiment of the present invention. The charging circuit of one embodiment of the present invention preferably includes the components included in the charging circuit described in the above embodiment. The charging circuit of one embodiment of the present invention may include a circuit having a function of converting voltage, current, or the like of supplied electric power. Examples of the circuit having a function of converting voltage, current, or the like of electric power include a regulator, a step-down circuit, a boosting circuit, a circuit having a function of converting AC power into DC power, a modulation circuit, a demodulation circuit, an amplifier circuit, and the like.

### [Vehicle]

First, an example in which the secondary battery management system of one embodiment of the present invention is used in an electric vehicle (EV) is described.

FIG. 18 illustrates a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 preferably has high output but does not necessarily have high capacity, and the capacity of the second battery 1311 is lower than that of the first batteries 1301a and 1301b.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DC-DC circuit 1306. In the case where a rear motor 1317 is provided for the rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DC-DC circuit 1310.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is used for the second battery 1311 due to cost advantage in many cases.

In this embodiment, an example in which lithium-ion secondary batteries are used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 through a motor controller 1303 or a battery controller 1302. Alternatively, the regenerative energy is stored in the first battery 1301a through the battery controller 1302 via the control circuit portion 1321. Alternatively, the regenerative energy is stored in the first battery 1301b through the battery controller 1302 via the control circuit portion 1321. For efficient charging with regenerative energy, the first batteries 1301a and 1301b are preferably capable of being rapidly charged.

The battery controller 1302 can set the charging voltage, charging current, and the like of the first batteries 1301a and 1301b. The battery controller 1302 can set charging conditions in accordance with charge characteristics of a secondary battery used, so that fast charge can be performed.

As the battery controller 1302, the charging circuit of one embodiment of the present invention can be used. In addition, the circuit having a function of converting voltage, current, or the like of electric power may be provided between the motor 1304 and the battery controller 1302. By using the charging circuit of one embodiment of the present invention as the battery controller 1302, the charge capacity of the first batteries 1301a and 1301b can be increased and the reliability of the first batteries 1301a and 1301b can be increased as well. Since the charge capacity of the first batteries 1301a and 1301b can be increased, the driving range of the electric vehicle can be increased. Furthermore, deterioration of the first batteries 1301a and 1301b can be inhibited, leading to a lower frequency of replacement of a battery in the electric vehicle. In addition, the reliability of the first batteries 1301a and 1301b can be increased, which can increase the safety of the electric vehicle.

Next, examples in which the secondary battery management system of one embodiment of the present invention is mounted on a vehicle, typically a transportation vehicle, will be described.

The use of the secondary battery management system of one embodiment of the present invention in vehicles enables production of next-generation clean energy vehicles such as hybrid electric vehicles (HVs), electric vehicles (EVs), or plug-in hybrid electric vehicles (PHVs). The secondary battery can also be mounted on transportation vehicles such as agricultural machines like an electric tractor, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, or spacecraft. With the use of the method for fabricating the secondary battery of one embodiment of the present invention, a large secondary battery can be fabricated. The secondary battery of one embodiment of the present invention can preferably be used in transportation vehicles.

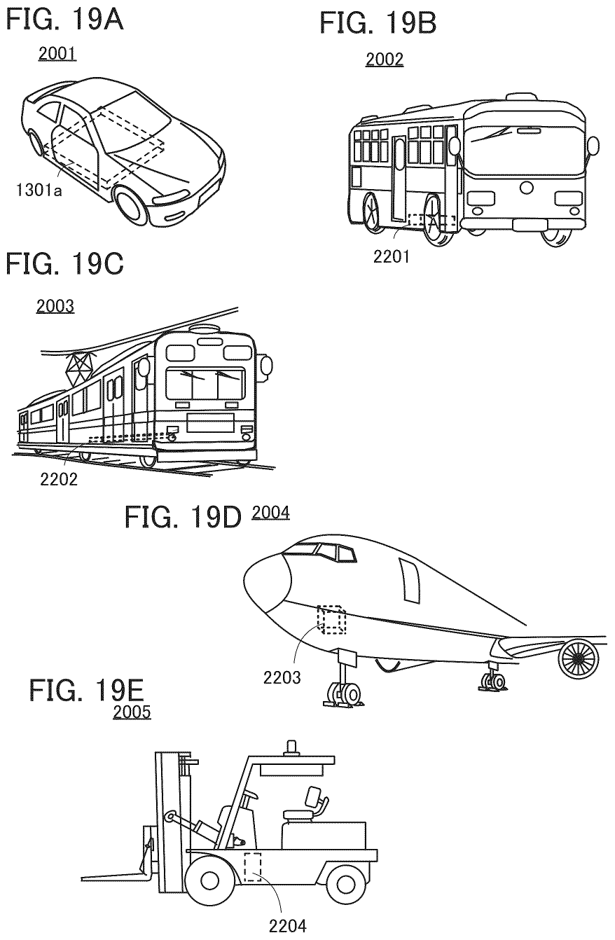

FIG. 19A to FIG. 19E illustrate transportation vehicles each using the secondary battery management system of one embodiment of the present invention. An automobile 2001 illustrated in FIG. 19A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery is provided at one position or several positions. The automobile 2001 illustrated in FIG. 19A includes the secondary battery management system of one embodiment of the present invention. The secondary battery management system includes the charging circuit of one embodiment of the present invention and the first battery 1301a illustrated in FIG. 18. The secondary battery management system may include a plurality of secondary batteries connected in series as an assembled battery. The assembled battery is electrically connected to the charging circuit of one embodiment of the present invention.

The secondary battery management system included in the automobile 2001 is supplied with electric power through external power supply equipment by a plug-in system, a contactless power feeding system, or the like. For supply of electric power, the standard of a connector and power supply system for a given method such as CHAdeMO (registered trademark) or Combined Charging System can be employed. Power may be supplied from a charging station provided in a commerce facility or a power source in a house.

In the charging circuit of one embodiment of the present invention, when charge is determined to be stopped, a signal to convey the charge stop can be transmitted to the charging station through a control circuit included in the charging circuit of one embodiment of the present invention. Alternatively, the charging station may include the charging circuit of one embodiment of the present invention. For example, the charging station may include at least part of the components of the charging circuit of one embodiment of the present invention, for example, may include a control circuit of the charging circuit of one embodiment of the present invention.

The automobile 2001 preferably has a function of converting AC power into DC power through a conversion device such as an AC-DC converter. In such a case, DC power obtained by conversion is supplied to the secondary battery management system, for example.

Although not illustrated, the vehicle may include a power receiving device so that it can be supplied with electric power from an above-ground power transmitting device in a contactless manner. In the case of the contactless power feeding system, by fitting a power transmitting device in a road or an exterior wall, power supply can be performed not only when the vehicle is stopped but also when driven. In addition, the contactless power feeding system may be utilized to perform transmission and reception of electric power between two vehicles. Furthermore, a solar cell may be provided in the exterior of the vehicle and supplied with power when the vehicle stops or moves. To supply electric power in such a contactless manner, an electromagnetic induction method or a magnetic resonance method can be used.

FIG. 19B illustrates a large transporter 2002 having a motor controlled by electricity as an example of a transportation vehicle. The secondary battery module of the transporter 2002 has a cell unit of four secondary batteries with 3.5 V or more and 4.7 V or lower, and 48 cells are connected in series to have 170 V as the maximum voltage. A secondary battery management system 2201 includes the charging circuit of one embodiment of the present invention and the secondary battery module. The secondary battery management system 2201 has the same function as that in FIG. 19A except the number of secondary batteries configuring the secondary battery module, for example; thus, the description is omitted.

FIG. 19C illustrates a large transportation vehicle 2003 having a motor controlled by electricity as an example. The transportation vehicle 2003 includes a secondary battery management system 2202. The secondary battery management system 2202 includes the charging circuit of one embodiment of the present invention and a secondary battery module. The secondary battery module has more than 100 secondary batteries with 3.5 V or more and 4.7 V or lower connected in series, and the maximum voltage is 600 V, for example. The secondary battery management system 2202 has the same function as that in FIG. 19A except the number of secondary batteries configuring the secondary battery module, for example; thus, the description is omitted.

FIG. 19D illustrates an aircraft 2004 having a combustion engine as an example. The aircraft 2004 illustrated in FIG. 19D is regarded as one kind of transportation vehicles because it has wheels for takeoff and landing, and includes a secondary battery management system 2203 that includes a charging circuit of one embodiment of the present invention and a secondary battery module configured by connecting a plurality of secondary batteries.

The secondary battery module of the aircraft 2004 has eight 4 V secondary batteries connected in series, which has the maximum voltage of 32 V, for example. The secondary battery management system 2203 has the same function as that in FIG. 19A except the number of secondary batteries configuring the secondary battery module, for example; thus, the description is omitted.

FIG. 19E illustrates a transportation vehicle 2005 that transports a load as an example. The transportation vehicle 2005 includes a secondary battery management system 2204. The secondary battery management system 2204 includes a charging circuit of one embodiment of the present invention and a secondary battery module. The transportation vehicle 2005 includes a motor controlled by electricity and executes various operations with the use of electric power supplied from secondary batteries configuring a secondary battery module of a secondary battery management system 2204. The transportation vehicle 2005 is not limited to operation by a human who rides thereon as a driver, and an unmanned operation is also possible by CAN communication or the like. Although FIG. 19E illustrates a forklift as an example, there is no particular limitation; a secondary battery management system of one embodiment of the present invention can be mounted on an industrial machine capable of being operated by CAN communication, e.g., an automatic transport machine, a working robot, or small construction equipment.

### [Building]

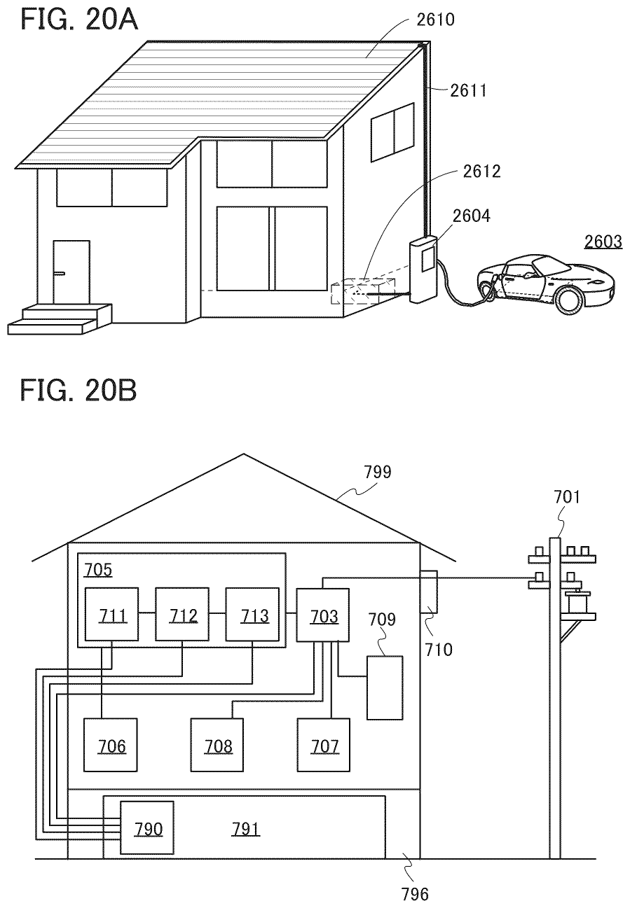

Next, examples in which the secondary battery management system of one embodiment of the present invention is mounted on a building will be described with reference to FIG. 20A and FIG. 20B.

A house illustrated in FIG. 20A includes a secondary battery management system 2612 and a solar panel 2610. The secondary battery management system 2612 includes, for example, an assembled battery including a plurality of secondary batteries. The secondary battery management system 2612 is electrically connected to the solar panel 2610 through a wiring 2611 or the like.

The secondary battery management system 2612 includes a charging circuit of one embodiment of the present invention. Electric power obtained by the solar panel 2610 can be stored in the secondary battery management system 2612 through the charging circuit.

The secondary battery management system 2612 may be electrically connected to a ground-based charging device 2604. In the charging circuit of the secondary battery management system 2612, when charge is determined to be stopped, a signal to convey the charge stop can be transmitted to the charging device 2604 through a control circuit included in the charging circuit. Alternatively, the charging device 2604 may include the charging circuit of one embodiment of the present invention. For example, the charging device 2604 may include at least part of the components of the charging circuit of one embodiment of the present invention, for example, a control circuit of the charging circuit of one embodiment of the present invention.

A secondary battery included in a vehicle 2603 can be charged with the electric power stored in the secondary battery management system 2612 through the charging device 2604. The secondary battery management system 2612 is preferably provided in an underfloor space. The secondary battery management system 2612 is preferably provided in the underfloor space, in which case the space on the floor can be effectively used. Alternatively, the secondary battery management system 2612 may be provided on the floor.

The electric power stored in the secondary battery management system 2612 can also be supplied to other electronic devices in the house. Thus, the electronic devices can be used with the secondary battery management system 2612 as an uninterruptible power source even when electric power cannot be supplied from the commercial power supply due to power failure or the like.

FIG. 20B illustrates an example of a secondary battery management system according to one embodiment of the present invention. As illustrated in FIG. 20B, a secondary battery management system 791 including a large secondary battery and the charging circuit of one embodiment of the present invention is provided in an underfloor space 796 of a building 799.

The secondary battery management system 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the secondary battery management system 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the secondary battery management system 791 and the amount of electric power supplied from the commercial power source 701. The predicting portion 712 has a function of predicting, on the basis of the amount of electric power consumed by the general load 707 and the power storage load 708 during a day, the demand for electric power to be consumed by the general load 707 and the power storage load 708 during the next day. The planning portion 713 has a function of making a charge-discharge plan of the secondary battery management system 791 on the basis of the demand for electric power predicted by the predicting portion 712.

The indicator 706 can show the amount of electric power consumed by the general load 707 and the power storage load 708 that is measured by the measuring portion 711. An electronic device such as a TV or a personal computer can also show it through the router 709. Furthermore, a portable electronic terminal such as a smartphone or a tablet can also show it through the router 709. The indicator 706, the electronic device, the portable electronic terminal, or the like can also show; for example, the demand for electric power depending on a time period (or per hour) that is predicted by the predicting portion 712.

### [Electronic Device]

The secondary battery of one embodiment of the present invention can be used for one or both of an electronic device and a lighting device, for example. Examples of the electronic device include portable information terminals such as mobile phones, smartphones, and laptop computers; portable game machines; portable music players; digital cameras; and digital video cameras.

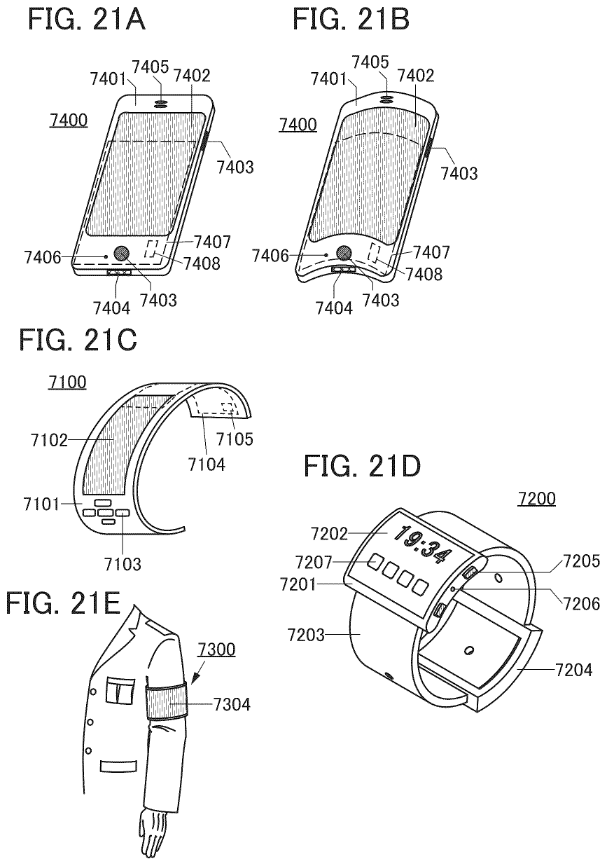

FIG. 21A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery management system. The secondary battery management system includes a secondary battery 7407 and a charging circuit 7408 electrically connected to the secondary battery 7407. The charging circuit 7408 can receive power supply from an external power source through the external connection port 7404. For example, power from an AC adapter is supplied to the external connection port 7404. The AC adapter has a function of converting AC power into DC power and supplying the DC power to the external connection port 7404. Alternatively, the mobile phone 7400 may have a function of converting AC power into DC power through a conversion circuit such as an AC-DC converter. In addition, the charging circuit 7408 may include a circuit of converting AC power into DC power.

Electric power may be supplied from an external power source to the mobile phone 7400 by wireless power feeding. As the wireless power feeding standard, the Qi standard or the like may be employed. A signal which is transmitted to the mobile phone 7400 by wireless power feeding is supplied to the charging circuit 7408 via a demodulation circuit or the like, for example. Alternatively, the charging circuit 7408 may include a circuit for wireless communication, for example, a modulation circuit or a demodulation circuit.

When the mobile phone 7400 includes a charging circuit of one embodiment of the present invention as the charging circuit 7408, the mobile phone 7400 can have higher safety. Furthermore, the discharge energy density of the secondary battery can be increased; therefore, the volume and weight of the secondary battery can be reduced, which enables the mobile phone 7400 to be reduced in size and weight. Furthermore, since the lifetime of the secondary battery can be increased, the mobile phone 7400 can be used over a long period without replacement of the secondary battery.

Since the charging circuit of one embodiment of the present invention has functions of both a charge control circuit and a protection circuit, the area or the number of chips included in the mobile phone 7400 can be reduced. Thus, the size and weight of the mobile phone 7400 can be reduced, and the reliability of the mobile phone 7400 can be increased.

FIG. 21B illustrates the mobile phone 7400 that is curved. When the whole mobile phone 7400 is bent by the external force, the secondary battery 7407 included in the mobile phone 7400 is also bent.

FIG. 21C illustrates an example of a bangle display device. A portable display device 7100 includes a housing 7101, a display portion 7102, an operation button 7103, and a secondary battery management system. The secondary battery management system includes a secondary battery 7104 and a charging circuit 7105 electrically connected to the secondary battery 7104. When the display device is worn on a user's arm while the secondary battery 7104 included in the secondary battery management system is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery is changed with a radius of curvature in the range of 40 mm to 150 mm. When the radius of curvature of the main surface of the secondary battery ranges from 40 mm to 150 mm, both inclusive, the reliability can be kept high.

FIG. 21D illustrates an example of a wrist-watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. In that case, for example, by mutual communication with a headset capable of wireless communication, hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes a secondary battery management system. For example, the secondary battery 7104 and the charging circuit 7105 illustrated in FIG. 21C can be provided the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 21E illustrates an example of an armband display device. The display device 7300 includes a display portion 7304 and a secondary battery management system. The secondary battery 7104 and the charging circuit 7105 illustrated in FIG. 21C can be incorporated in the display device 7300. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

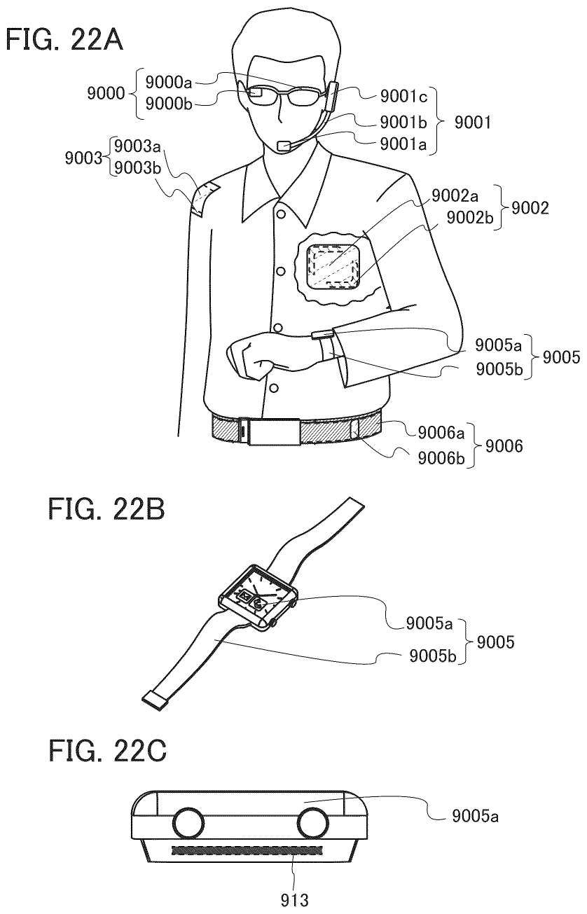

FIG. 22A illustrates examples of wearable devices. A secondary battery management system is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery management system of one embodiment of the present invention can be provided in a glasses-type device 9000 illustrated in FIG. 22A. The glasses-type device 9000 includes a frame 9000a and a display part 9000b. The secondary battery management system is provided in a temple of the frame 9000a having a curved shape, whereby the glasses-type device 9000 can be lightweight, can have a well-balanced weight, and can be used continuously for a long time. With the use of the secondary battery management system of one embodiment of the present invention, energy density of the secondary battery management system can be increased, space saving required with downsizing of a housing can be achieved.

The secondary battery management system of one embodiment of the present invention can be provided in a headset-type device 9001. The headset-type device 9001 includes at least a microphone portion 9001a, a flexible pipe 9001b, and an earphone portion 9001c. The secondary battery management system can be provided in the flexible pipe 9001b or the earphone portion 9001c. With the use of the secondary battery management system of one embodiment of the present invention, space saving required with downsizing of a housing can be achieved.

The secondary battery management system of one embodiment of the present invention can be provided in a device 9002 that can be attached directly to a body. A secondary battery management system 9002b can be provided in a thin housing 9002a of the device 9002. With the use of the secondary battery management system of one embodiment of the present invention, space saving required with downsizing of a housing can be achieved.

The secondary battery management system of one embodiment of the present invention can be provided in a device 9003 that can be attached to clothes. A secondary battery management system 9003b can be provided in a thin housing 9003a of the device 9003. With the use of the secondary battery management system of one embodiment of the present invention, space saving required with downsizing of a housing can be achieved.

The secondary battery management system of one embodiment of the present invention can be provided in a belt-type device 9006. The belt-type device 9006 includes a belt portion 9006a and a wireless power feeding and receiving portion 9006b, and the secondary battery management system can be provided inside the belt portion 9006a. With the use of the secondary battery management system of one embodiment of the present invention, space saving required with downsizing of a housing can be achieved.

The secondary battery management system of one embodiment of the present invention can be provided in a watch-type device 9005. The watch-type device 9005 includes a display portion 9005a and a belt portion 9005b, and the secondary battery management system can be provided in the display portion 9005a or the belt portion 9005b. With the use of the secondary battery management system of one embodiment of the present invention, space saving required with downsizing of a housing can be achieved.

The display portion 9005a can display various kinds of information such as time and reception information of an e-mail and an incoming call.

In addition, the watch-type device 9005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 22B is a perspective view of the watch-type device 9005 that is detached from an arm.

FIG. 22C is a side view. FIG. 22C illustrates a state where the secondary battery management system 913 of one embodiment of the present invention is incorporated. The secondary battery management system 913, which is small and lightweight, overlaps with the display portion 9005a.

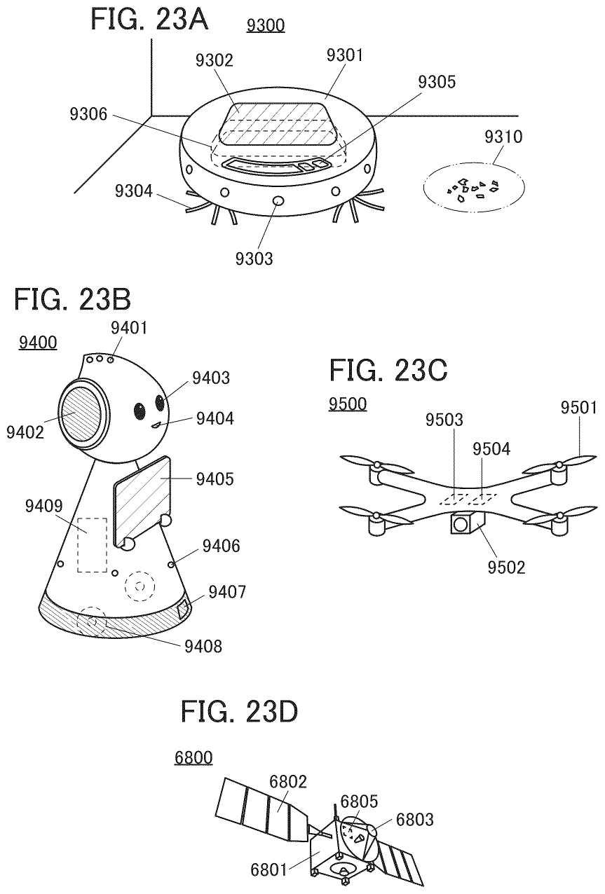

FIG. 23A illustrates an example of a cleaning robot. A cleaning robot 9300 includes a display portion 9302 placed on the top surface of a housing 9301, a plurality of cameras 9303 placed on the side surface of the housing 9301, a brush 9304, operation buttons 9305, a secondary battery management system 9306, a variety of sensors, and the like. Although not illustrated, the cleaning robot 9300 is provided with a tire, an inlet, and the like. The cleaning robot 9300 is self-propelled, detects dust 9310, and sucks up the dust through the inlet provided on the bottom surface.

For example, the cleaning robot 9300 can determine whether there is an obstacle such as a wall, furniture, or a step by analyzing images taken by the cameras 9303. In the case where the cleaning robot 9300 detects an object, such as a wire, that is likely to be caught in the brush 9304 by image analysis, the rotation of the brush 9304 can be stopped. The cleaning robot 9300 includes the secondary battery management system 9306 of one embodiment of the present invention and a semiconductor device or an electronic component. The cleaning robot 9300 using the secondary battery management system 9306 of one embodiment of the present invention can be a highly reliable electronic device that can operate for a long time.

FIG. 23B illustrates an example of a robot. A robot 9400 illustrated in FIG. 23B includes a secondary battery management system 9409, an illuminance sensor 9401, a microphone 9402, an upper camera 9403, a speaker 9404, a display portion 9405, a lower camera 9406, an obstacle sensor 9407, a moving mechanism 9408, an arithmetic device, and the like.

The microphone 9402 has a function of detecting a speaking voice of a user, an environmental sound, and the like. The speaker 9404 has a function of outputting sound. The robot 9400 can communicate with a user using the microphone 9402 and the speaker 9404.

The display portion 9405 has a function of displaying various kinds of information. The robot 9400 can display information desired by a user on the display portion 9405. The display portion 9405 may be provided with a touch panel. Moreover, the display portion 9405 may be a detachable information terminal, in which case charging and data communication can be performed when the display portion 9405 is set at the home position of the robot 9400.

The upper camera 9403 and the lower camera 9406 each have a function of taking an image of the surroundings of the robot 9400. The obstacle sensor 9407 can detect the presence of an obstacle in the direction where the robot 9400 advances with the moving mechanism 9408. The robot 9400 can move safely by recognizing the surroundings with the upper camera 9403, the lower camera 9406, and the obstacle sensor 9407.

The robot 9400 includes the secondary battery management system 9409 of one embodiment of the present invention and a semiconductor device or an electronic component. The robot 9400 using the secondary battery management system of one embodiment of the present invention can be a highly reliable electronic device that can operate for a long time.

FIG. 23C illustrates an example of a flying object. A flying object 9500 illustrated in FIG. 23C includes propellers 9501, a camera 9502, a secondary battery management system 9503, and the like and has a function of flying autonomously.

For example, image data taken by the camera 9502 is stored in an electronic component 9504. The electronic component 9504 can analyze the image data to detect whether there is an obstacle in the way of the movement. Moreover, the electronic component 9504 can estimate the remaining battery level from a change in the power storage capacity of the secondary battery management system 9503. The flying object 9500 includes the secondary battery management system 9503 of one embodiment of the present invention. The flying object 9500 using the secondary battery management system of one embodiment of the present invention can be a highly reliable electronic device that can operate for a long time.

FIG. 23D illustrates an artificial satellite 6800 as an example. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

As the system for controlling the secondary battery 6805 included in the artificial satellite 6800, the secondary battery management system of one embodiment of the present invention is preferably provided. In the case where the secondary battery 6805 included in the artificial satellite 6800 is controlled, power of each circuit included in the charging circuit may be supplied from a secondary battery or a power supply device different from the secondary battery 6805.

The secondary battery 6805 included in the artificial satellite 6800 may have substantially the same temperature as the space when a heater or the like is not provided. In the case where the temperature of the secondary battery 6805 is measured, the temperature of the exterior body of the secondary battery or the temperature of the housing in which the exterior body is placed may be measured. Even when the temperature is substantially equal to the temperature of the space, the upper limit voltage can be determined by the secondary battery management system.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

This embodiment can be implemented in appropriate combination with the other embodiments.

### Example

In this example, data on the battery characteristics of a secondary battery using graphite for a negative electrode is shown. A secondary battery management system 100 can detect the local maximum value in the battery characteristics data.

### <Formation of Positive Electrode Active Material>

A positive electrode active material was formed.

As lithium cobalt oxide (LiCoO₂) in Step S14 shown in FIG. 12, commercially available lithium cobalt oxide (Cellseed C-10N produced by NIPPON CHEMICAL INDUSTRIAL CO., LTD.) not containing any additive element was prepared.

In accordance with Step S15 shown in FIG. 12, lithium cobalt oxide was heated at 850° C. in an oxygen atmosphere for two hours. For the oxygen atmosphere, oxygen was prevented from entering and leaving the reaction chamber.

In accordance with Step S20a shown in FIG. 12, an A1 source was prepared as an additive element source. Lithium fluoride and magnesium fluoride were used as the A1 source, and lithium fluoride and magnesium fluoride were weighed at the molar ratio of 1:3. These were mixed to give a mixture to be the A1 source. The mixture is referred to as a magnesium source or a fluorine source in some cases.

Next, magnesium in the magnesium source was weighed such that the cobalt in lithium cobalt oxide was 1 at %. After that, in accordance with Step S31 shown in FIG. 12, heated lithium cobalt oxide and the magnesium source were mixed, whereby a mixture 903 in Step S32 shown in FIG. 12 was obtained. The mixture 903 is referred to as a mixture A.

Next, in accordance with Step S33 shown in FIG. 12, the mixture A was heated at 900° C. in an oxygen atmosphere for 20 hours. For the oxygen atmosphere, oxygen was prevented from entering and leaving the reaction chamber. A composite oxide in Step S34a shown in FIG. 12 was obtained. The composite oxide is referred to as a composite oxide A.

Next, in accordance with Step S40 shown in FIG. 12, a A2 source was prepared as an additive element source. For the A2 source, nickel hydroxide was prepared as a nickel source, and aluminum hydroxide was prepared as an aluminum source. Nickel and aluminum were weighed so that nickel in the nickel hydroxide and aluminum in the aluminum hydroxide are each 0.5 at % of cobalt in the composite oxide A, and were mixed with the composite oxide A to give a mixture 904 in Step S52 shown in FIG. 12. The mixture 904 is referred to as a mixture B.

Next, in accordance with Step S53 shown in FIG. 12, the mixture B was heated at 850° C. in an oxygen atmosphere for ten hours, whereby the positive electrode active material 10 in Step S54 shown in FIG. 12 was obtained. The positive electrode active material 10 is referred to as a sample Sal.

### <Fabrication of Positive Electrode>

Sample Sal, acetylene black (AB), polyvinylidene fluoride (PVDF), and NMP were mixed to form a slurry. The ratio of Sample Sal, AB, and PVDF was 95:3:2 (weight ratio).

The obtained slurry was applied to one surface of an aluminum foil that is a current collector. After that, heat treatment was performed at 80° C., so that the NMP was volatilized. Pressing was performed after the heat treatment, so that a positive electrode was obtained.

### <Fabrication of Negative Electrode>

Graphite, VGCF (registered trademark)-H (manufactured by SHOWA DENKO K.K., the fiber diameter: 150 nm, the specific surface area: 13 m²/g), carboxymethyl cellulose sodium salt (CMC-Na), styrene butadiene rubber (SBR), and water were mixed to form a slurry. The ratio of graphite, VGCF, CMC-Na, and SBR was 96:1:1:2 (weight ratio).

The obtained slurry was applied to one surface of a copper foil that is a current collector. After that, heating was performed at 50° C., so that a negative electrode was obtained.

### <Fabrication of Secondary Battery>

A secondary battery was fabricated using the positive electrode and the negative electrode formed through the above steps. An electrolyte solution contains ethylene carbonate (EC) and diethyl carbonate (DEC) as an organic solvent, and when the total content of EC and DEC is 100 vol %, the volume ratio of EC to DEC was EC:DEC=30:70 (volume ratio). A solution in which lithium hexafluorophosphate (LiPF₆) was dissolved in this organic solvent at a concentration of 1 mol/L was used as the electrolyte solution. For the separator, polypropylene was used. As a film to be the exterior body, a film in which a polypropylene layer, an acid modified polypropylene layer, an aluminum layer, and a nylon layer were stacked in this order was used.

Through the above steps, a secondary battery was fabricated.

<dt/dV>

A charge and discharge cycle test of the fabricated secondary battery was performed at a temperature of −20° C. Specifically, the exterior body of the secondary battery was sandwiched between metal plates and put in a thermostatic bath in a state where a temperature sensor is provided in the metal plate, and the temperature of the thermostatic bath was set to −20° C.; after the temperature of the temperature sensor showed −20° C., the charge and discharge cycle test was started. As the charging condition, only constant current charging at 0.1 C (1 C=40 mA/h) was performed and constant voltage charging was not performed. The upper limit voltage at the constant current charging was set to 5 V, constant current discharging at 0.1 C was performed as the discharging conditions, and the lower limit voltage at the constant current charging was set to 2 V. A break period longer than or equal to 5 minutes and shorter than or equal to 15 minutes may be provided between charging and discharging, and a break period of 10 minutes was provided in this charge and discharge cycle test. The environmental temperature in the break period was also set to −20° C.

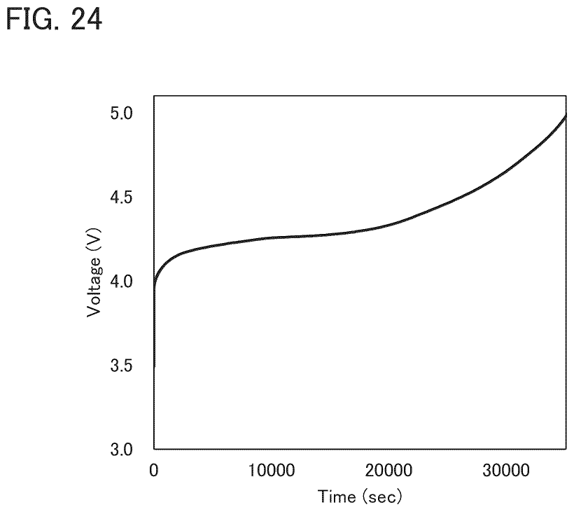

FIG. 24 is a graph relating to the voltage change of the secondary battery with respect to time. The secondary battery management system 100 can obtain the above graph with the use of the control circuit or the like described in the above embodiments or the like.

When the local maximum value shown in FIG. 24 is confirmed, the local maximum value can be detected by the control circuit.

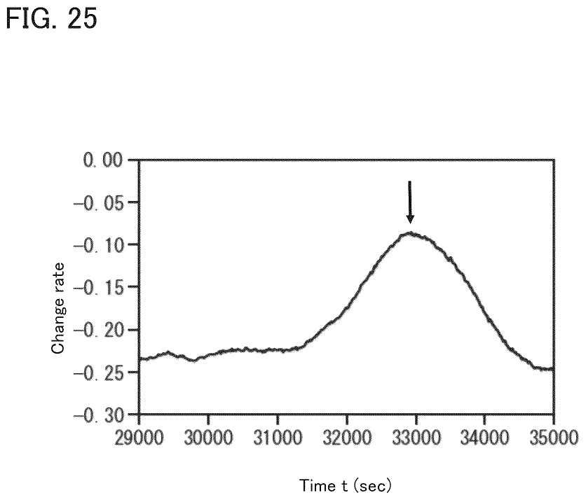

In this example, a clear local maximum value was not observed in the graph shown in FIG. 24; thus, the next processing was performed by the control circuit. Specifically, the change rate was calculated as shown in FIG. 25. In consideration of the upper limit voltage in the constant current charging in this example, a voltage lower than or equal to 4.5 V can be ignored. FIG. 24 shows that the voltage 4.5 V corresponds to the time 29000 seconds. Thus, FIG. 25 shows the change rate after 29000 seconds or more. In the graph shown in FIG. 25, a local maximum value was observed in a portion denoted by the arrow. The control circuit can stop charging when detecting the local maximum value.

### REFERENCE NUMERALS

10: positive electrode active material, 100A: secondary battery management system, 100B: secondary battery management system, 100: secondary battery management system, 101: charging circuit, 103: separator, 106: positive electrode layer, 107: negative electrode layer, 108: electrolyte solution, 121: secondary battery, 122: resistor, 123: resistor, 124: terminal, 125: terminal, 140: transistor, 150: transistor, 151: voltage measuring circuit, 152: current measuring circuit, 153: control circuit, 154: memory circuit, 156: temperature sensor, 161: subtractor, 185: detection circuit, 186: detection circuit, 200: secondary battery management system, 300: hold circuit, 301: comparator, 302: DA converter, 303: comparison resistor, 304: second control circuit, 305: clock generation circuit, 501: positive electrode tab, 504: negative electrode tab, 509: exterior body, 510: positive electrode lead electrode, 511: negative electrode lead electrode, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: secondary battery management system, 796: underfloor space, 799: building, 903: mixture, 904: mixture, 913: secondary battery management system, 1301a: first battery, 1301b: first battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: second battery, 1312: inverter, 1313: audio, 1314: power window, 1315: lamp, 1316: tire, 1317: rear motor, 1321: control circuit portion, 1800: center of curvature, 1803: adhesive layer, 1805: exterior body, 1807: bonding region, 1808: region, 1810: space, 2001: automobile, 2002: transporter, 2003: transport vehicle, 2004: aircraft, 2005: transport vehicle, 2201: secondary battery management system, 2202: secondary battery management system, 2203: secondary battery management system, 2204: secondary battery management system, 2603: vehicle, 2604: charging device, 2610: solar panel, 2611: wiring, 2612: secondary battery management system, 6800: artificial satellite, 6801: body, 6802: solar panel, 6803: antenna, 6805: secondary battery, 7100: portable display device, 7101: housing, 7102: display portion, 7103: operation button, 7104: secondary battery, 7105: charging circuit, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone device, 7401: housing, 7402: display portion, 7403: operation button, 7404: external connection port, 7405: speaker, 7406: microphone, 7407: secondary battery, 7408: charging circuit, 9000a: frame, 9000b: display portion, 9000: glasses-type device, 9001a: microphone portion, 9001b: flexible pipe, 9001c: earphone portion, 9001: headset-type device, 9002a: housing, 9002b: secondary battery management system, 9002: device, 9003a: housing, 9003b: secondary battery management system, 9003: device, 9005a: display portion, 9005b: belt portion, 9005: watch-type device, 9006a: belt portion, 9006b: wireless power feeding and receiving portion, 9006: belt-type device, 9300: cleaning robot, 9301: housing, 9302: display portion, 9303: camera, 9304: brush, 9305: operation button, 9306: secondary battery management system, 9310: dust, 9400: robot, 9401: illumination sensor, 9402: microphone, 9403: upper camera, 9404: speaker, 9405: display portion, 9406: lower camera, 9407: obstacle sensor, 9408: moving mechanism, 9409: secondary battery management system, 9500: flying object, 9501: propeller, 9502: camera, 9503: secondary battery management system, 9504: electronic component

1. A secondary battery management system comprising:
a secondary battery that is charged and discharged at higher than or equal to −50° C. and lower than or equal to 0° C.;
a first circuit which is configured to measure a voltage of the secondary battery;
a second circuit which is configured to measure a current of the secondary battery; and
a control circuit to which information on voltage from the first circuit and information on current from the second circuit is input,
wherein the control circuit starts charging to the secondary battery,
wherein the control circuit performs arithmetic operation of data showing battery characteristics on the basis of a value input from the first circuit or the second circuit,
wherein the control circuit detects a local maximum value of the data, and
wherein the control circuit stops the charging when detecting the local maximum value.

2. A secondary battery management system comprising:
a secondary battery that is charged and discharged at higher than or equal to −50° C. and lower than or equal to 0° C.;
a first circuit which is configured to measure a voltage of the secondary battery;
a second circuit which is configured to measure a current of the secondary battery;
control circuit to which information on voltage from the first circuit and information on current from the second circuit is input; and
a temperature sensor electrically connected to the control circuit,
wherein the control circuit measures a temperature of the secondary battery using the temperature sensor,
wherein the control circuit starts charging to the secondary battery,
wherein the control circuit performs arithmetic operation of data showing battery characteristics on the basis of a value input from the first circuit or the second circuit,
wherein the control circuit detects a local maximum value of the data, and
wherein the control circuit stops the charging when detecting the local maximum value.

3. A secondary battery management system comprising:
a secondary battery that is charged and discharged at higher than or equal to −50° C. and lower than or equal to 0° C.;
a first circuit which is configured to measure a voltage of the secondary battery;
a second circuit which is configured to measure a current of the secondary battery; and
a control circuit to which information on voltage from the first circuit and information on current from the second circuit is input,
wherein the control circuit stores a temperature of the secondary battery in a memory circuit,
wherein the control circuit starts charging to the secondary battery,
wherein the control circuit performs arithmetic operation of a dt/dV value showing the battery characteristics on the basis of the temperature on the basis of a value input from the first circuit or the second circuit,
wherein the control circuit detects a local maximum value of the dt/dV, and
wherein the control circuit stops the charging when detecting the local maximum value.

4. The secondary battery management system according to claim 3,
wherein the control circuit performs averaging processing on the dt/dV, and divides a difference value between a second value and a first value of the dt/dV in a comparison range by the first value.

5. The secondary battery management system according to claim 1,
wherein the charging is performed with a constant current.

6. The secondary battery management system according to claim 1,
wherein the secondary battery comprises a positive electrode, and
wherein the positive electrode comprises lithium cobalt oxide, and a crystal structure of the lithium cobalt oxide identified by X-ray diffraction is a space group R-3m.

7. The secondary battery management system according to claim 6,
wherein the lithium cobalt oxide comprises magnesium in a surface portion.

8. The secondary battery management system according to claim 1,
wherein the secondary battery comprises a negative electrode, and
wherein the negative electrode comprises lithium metal or graphite.

9. The secondary battery management system according to claim 2,
wherein the charging is performed with a constant current.

10. The secondary battery management system according to claim 3,
wherein the charging is performed with a constant current.

11. The secondary battery management system according to claim 2,
wherein the secondary battery comprises a positive electrode, and
wherein the positive electrode comprises lithium cobalt oxide, and a crystal structure of the lithium cobalt oxide identified by X-ray diffraction is a space group R-3m.

12. The secondary battery management system according to claim 11,
wherein the lithium cobalt oxide comprises magnesium in a surface portion.

13. The secondary battery management system according to claim 3,
wherein the secondary battery comprises a positive electrode, and
wherein the positive electrode comprises lithium cobalt oxide, and a crystal structure of the lithium cobalt oxide identified by X-ray diffraction is a space group R-3m.

14. The secondary battery management system according to claim 13,
wherein the lithium cobalt oxide comprises magnesium in a surface portion.
